(19) United States
(12) Patent Application Publication
(10) Pub. No.: US 2006/0167592 A1
(43) Pub. Date: Jul. 27, 2006

(54) Execution support system and execution support method

(76) Inventors: Takahiro Kudo, Katano-shi (JP); Satoshi Matsuura, Kyotanabe-shi (JP); Jun Ozawa, Nara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/546,659

(22) PCT Filed: Jan. 20, 2004
(86) PCT No.: PCT/JP04/00417

§ 371 Date: Aug. 23, 2005

(30) Foreign Application Priority Data
Feb. 25, 2003 (JP) 2003-047154

(51) Int. Cl. G06F 17/00

(52) U.S. Cl. 701/1; 701/200

(57) ABSTRACT

An execution support system 1 including a car navigation system terminal 100 that communicates with TVs (291 and 292) or air conditioners (293 and 294) via an Internet (900), where the car navigation system terminal (100) includes: a prediction function unit (110) that predicts a destination to which it is headed and outputs prediction result data indicating a result of the prediction; and a script function unit (120) that specifies a control operation for the respective TVs (291 and 292) and the air conditioners (293 and 294) in accordance with the prediction result data, and causes the respective TVs (291 and 292) and the air conditioners (293 and 294) to execute the specified control operation.

### TECHNICAL FIELD

The present invention relates to an execution support system and an execution support method for supporting devices such as home electric appliances and terminals that are set in a hospital or in a store, execute a control operation.

### BACKGROUND ART

An execution support system for causing a device located in a destination, to execute a predetermined control using a mobile terminal such as a mobile phone is suggested as a conventional art (see reference to, e.g., Japanese Laid-Open Patent Application No. 2002-345051 (hereinafter to be referred to as “patent literature 1”) and No. 2002-78047 (hereinafter to be referred to as “patent literature 2”).

The execution support system according to the patent literature 1 (i.e. a communication apparatus intended for home electric appliance) includes a cell phone, a home terminal set at home for communication with the cell phone, and plural home electric appliances connected to the home terminal, and controls each of the home electric appliances according to instructions from the cell phone.

Thus, for example, it is possible for the user carrying a cell phone, to operate the cell phone from where he/she is in order to turn an air conditioner on so that the room is warmed up before he/she gets home.

The execution support system according to the patent literature 2 includes a cell phone, a gateway set at home and plural electric appliances connected to the gateway and a server that communicates with the respective cell phone and gateway. The server recognizes that a pre-set time has come based on a self-installed timer, and causes, via the gateway, each of the electric appliances to perform a control operation based on the information transmitted from the communication apparatus.

Thus it is possible, for example, to previously set an alarm so that an air conditioner being one of the electric appliances is turned on at 20:00 every night before the user gets home. The user thus does not need to operate the air conditioner every time.

The execution support system according to the patent literature 1, however, has a problem that it requires the user to take the trouble to operate the cell phone each time he/she desires to turn the air conditioner on.

As for the execution support system according to the patent literature 2, since an electric appliance is operated at a pre-set time, it is possible to eliminate the user's operation as is required under the execution support system according to the patent literature 1. The problem, however, is that in the case where the time at which the user comes home changes during the week, the user needs to operate the cell phone to change the pre-set time.

The present invention is conceived in view of the above problem, and an object of the present invention is to provide an execution support system and a method thereof for supporting a device execute a control operation according to the user's behavior while eliminating cumbersome operations imposed on the user.

### DISCLOSURE OF INVENTION

In order to achieve the above object, the execution support system according to the present invention is an execution support system for supporting a predetermined device execute a control operation and includes: a mobile terminal that predicts a destination to which the terminal is headed, and outputs prediction result data indicating a result of the prediction; a control operation specification unit operable to specify a control operation of the device, the control operation being specified according to the outputted prediction result data; and an execution unit operable to cause the device to execute the control operation specified by the control operation specification unit. The mobile terminal is a terminal that can detect a location of, for instance, a terminal, a cell phone and a Personal Digital Assistant (PDA), which are used in a car navigation system.

Thus, the mobile terminal predicts a destination to which it is headed, and the device executes its control function according to a result of the prediction. Therefore, in the case where the user carries his/her mobile terminal as he/she moves, it is possible to eliminate the troublesome operation imposed on the user, and to support the device execute a control operation according to the user's behavior.

The control operation specification unit is operable to hold registration information in which a facility and a control operation corresponding to the facility are registered, and to specify a control operation that corresponds to a destination facility indicated in the prediction result data.

Thus, it is possible to support the device execute a control operation based on the registration information.

All or part of facilities in the registration information may be registered in association with a category to which each facility belong, and the control operation specification unit may be operable to judge whether or not the destination facility indicated in the prediction result data belongs to a predetermined category, and to specify a control operation corresponding to the predetermined category in the control operations registered in the registration information, in the case where it is judged that the destination facility belongs to the predetermined category.

Thus, in the case where the mobile terminal predicts a specific store such as “Eco-eco Mart” and “Niko-niko Mart” as its own destination, it is judged that the specific store belongs to a category “supermarket” and a control operation that falls into the category is specified. Therefore, it is possible to support the device execute a control operation corresponding to a category to which the destination belongs.

A period of time related to each control may be registered in the registration information, and the control operation specification unit is further operable to specify a control operation associated with a period of time including a time indicated in the prediction result data.

Thus, it is possible to support the device execute a control operation in accordance with the destination of the mobile terminal and the period of time which are related to the operation.

Identification information for identifying a device that executes a control operation may be registered in the registration information in association with each control, the control operation specification unit may be operable to specify, among the control operations registered into the registration information, a control operation indicated in the prediction result data and identification information of a device that executes the control operation, and the execution unit may be operable to cause the device indicated in the identification information specified by the control operation specification unit.

Thus, even in the case where plural devices are connected to the system, the device to which control should be performed is specified by the identification information included in the registration information. It is therefore possible to support the specified device execute the control operation.

User identification information for identifying each user may be registered in the registration information in association with each control, the mobile terminal may output user identification of a user operating the terminal, and the control operation specification unit may be operable to specify, among the control operations registered in the registration information, a control operation that is further indicated in the user identification information outputted by the mobile terminal.

Thus, it is possible to support the device execute a control operation in accordance with the destination of the mobile terminal and the user.

Note that the present invention can be realized as a mobile terminal or a server included in the execution support system as described above, or even as an execution support method used in such execution support system.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a structural diagram showing a structure of an execution support system according to a first embodiment of the present invention;

FIG. 2 is a function block diagram showing a functional structure of a car navigation system terminal according to the first embodiment;

FIG. 3 is a function block diagram showing a functional structure of a home gateway according to the first embodiment;

FIG. 4 is an information display diagram showing details included in map information according to the first embodiment;

FIGS. 5A and 5B are information display diagrams, each of which shows details included in history information according to the first embodiment;

FIG. 6 is an information display diagram showing an example of details included in transition-state information;

FIGS. 7A, 7B and 7C are information display diagrams, each of which shows details included in a condition table according to the first embodiment;

FIG. 8 is an operational flowchart showing a sequence of operations performed by a prediction function unit of the car navigation according to the first embodiment;

FIGS. 9A, 9B and 9C are information display diagrams, each of which shows information included in a condition table with tree structure according to the first embodiment;

FIG. 10 is an operational flowchart showing a sequence of operations performed by a prediction function unit of the car navigation system terminal according to the first embodiment;

FIG. 11 is a diagram showing an example of a script format according to the first embodiment;

FIG. 12 is a format display diagram showing details included in control instruction data according to the first embodiment;

FIG. 13 is an information display diagram showing details included in parameter data according to the first embodiment;

FIGS. 14A and 14B are script display diagrams respectively showing an example of a script according to the first embodiment;

FIG. 15 is an information display diagram showing details included in user information according to the first embodiment;

FIG. 16 is an information display diagram showing details included in local address information according to the first embodiment;

FIG. 17 is a sequence diagram showing an operation performed in the execution support system according to the first embodiment;

FIG. 18 is a screen display diagram showing a TV screen on which a script is executed, according to the first embodiment;

FIG. 19 is a structural diagram showing a structure of an execution support system according to a second embodiment of the present invention;

FIG. 20 is a function block diagram showing functional structures of a server and a car navigation system terminal according to the second embodiment;

FIG. 21 is an information display diagram showing details included in registration information according to the second embodiment;

FIG. 22 is a screen display diagram showing an example of a screen of the terminal that is set in a hospital, according to the second embodiment;

FIG. 23 is an information display diagram showing details included in user information according to the second embodiment;

FIGS. 24(a) through 24(g) are screen display diagrams for describing screens to be displayed by a display unit according to the second embodiment;

FIGS. 25(a) through 25(g) are screen display diagrams for describing other screens to be displayed by the display unit according to the second embodiment;

FIG. 26 is a format display diagram showing an example of a script format according to the second embodiment;

FIG. 27 is a script display diagram showing an example of a script according to the second embodiment;

FIG. 28 is a sequence diagram showing an operation performed in the execution support system according to the second embodiment;

FIG. 29 is a structural diagram showing a structure of an execution support system according to a third embodiment;

FIG. 30 is a function block diagram showing functional structures of a car navigation system terminal, server and home terminal according to the third embodiment;

FIG. 31 is an information display diagram showing details included in user group information according to the third embodiment;

FIGS. 32(a), 32(b) and 32(c) are screen display diagrams respectively showing an example of a screen that a registration unit allows a display unit of the home terminal to display, according to the third embodiment;

FIG. 33 is an information display diagram showing details included in registration information according to the third embodiment;

FIG. 34 is an operational flowchart showing an operation performed by a registration function unit of a server according to the third embodiment;

FIG. 35 is an information display diagram showing details included in category information according to the third embodiment;

FIGS. 36A and 36B are screen display diagrams respectively showing an example of a screen to be displayed by a message display unit of a car navigation system terminal according to the third embodiment, while FIG. 36C is a screen display diagram showing a screen displayed by a message display unit of a cell phone according to the third embodiment; and

FIG. 37 is an operational flowchart showing an operation performed by a search extraction function unit of a server according to the third embodiment.

### BEST MODE FOR CARRYING OUT THE INVENTION

### First Embodiment

The following describes the execution support system according to the first embodiment of the present invention with reference to the diagrams.

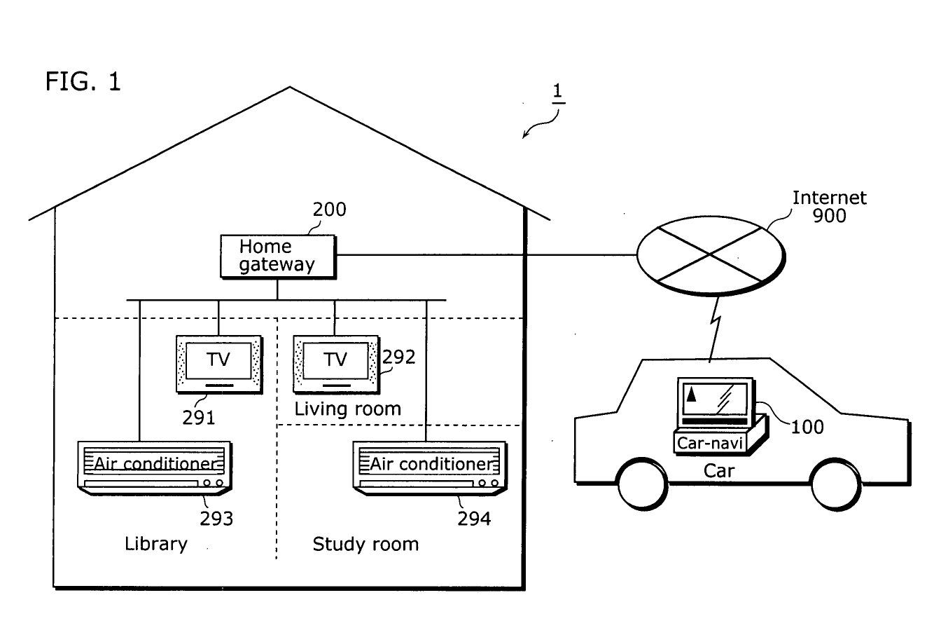

FIG. 1 is a structural diagram showing a structure of the execution support system according to the present embodiment.

The execution support system 1 of the present embodiment supports devices execute a control operation in accordance with the user's behavior while eliminating the cumbersome operations imposed on the user. Such execution support system 1 includes a car navigation system terminal 100 placed in a car (hereafter to be called “car-navi”), a home gateway 200 set at home, TVs 291 and 292 as well as air conditioners 293 and 294 which are connected to the home gateway 200.

According to such execution support system 1 of the present embodiment, the car-navi 100 predicts a destination to which it is headed for, and the respective TVs 291 and 292 as well as the air conditioners 293 and 294 are allowed to execute control according to a result of the prediction. For example, when the user using the car-navi 100 is on the way home where the air conditioners 293 and 294 are placed, the car-navi 100 predicts that the car-navi is heading for home, turns on the air conditioner 293 or allows the TV 291 to display a message that informs that the user is on the way to get home.

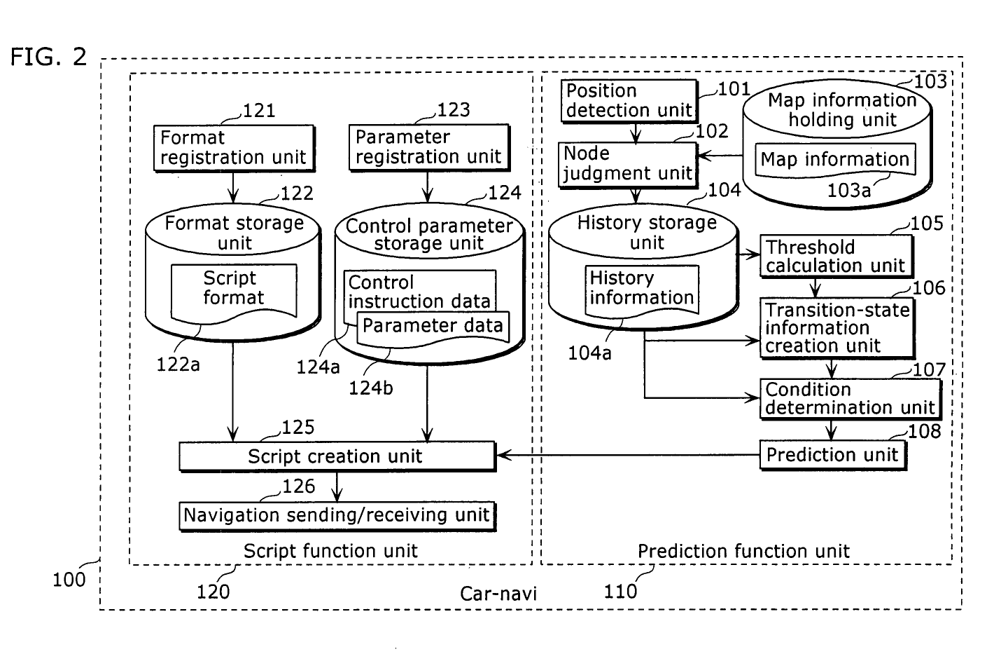

FIG. 2 is a functional block diagram showing the functional structure of the car-navi 100.

The car-navi 100 communicates with the home gateway via an Internet 900, and includes: a prediction function unit 110 that predicts a destination where the car-navi 100 is heading for; and a script function unit 120 that creates a script instructing a predetermined device to execute a predetermined operation based on the prediction result, and transmits the created script.

The prediction function unit 110 of the car-navi 100 includes the following: a location detection unit 101 that detects a present position of the car-navi 100 using, for instance, a Global Positioning System (GPS); a map information holding unit 103 that previously holds map information 103a indicating a map used for navigation; a node judgment unit 102 that judges whether or not the present position detected by the location detection unit 101 corresponds to a node that will be mentioned later; a history storage unit 104 having an area for storing, as history information 104a, the node that corresponds to the present position; a threshold calculation unit 105 that determines a threshold of occurrence frequency for creating transition-state information that will be mentioned later; a transition-state information creation unit 106 which creates transition-state information related to a transition between nodes, each having an occurrence frequency equal to or greater than the threshold, and which includes frequency as well as date and time of the movement between the nodes; a condition determination unit 107 that determines a predetermined condition based on the transition-state information and the history information 104a; and a prediction unit 108 that predicts a node to be the next destination based on the transition-state information using the condition determined by the condition determination unit 107.

The script function unit 120 of the car-navi 100 includes: a format storing unit 122 having an area for storing a script format 122a; a format registration unit 121 that registers the script format 122a into the format storing unit 122; a control parameter storing unit 124 having an area for storing control instruction data 124a and parameter data 124b; a parameter registration unit 123 that registers the control instruction data 124a and the parameter data 124b into the control parameter storing unit 124; a script creation unit 125 that creates a script according to the result of the prediction performed by the prediction unit 108, using the script format 122a, the control instruction data 124 and the parameter data 124b; and a navigation sending/receiving unit 126 that sends/receives signals via the Internet 900.

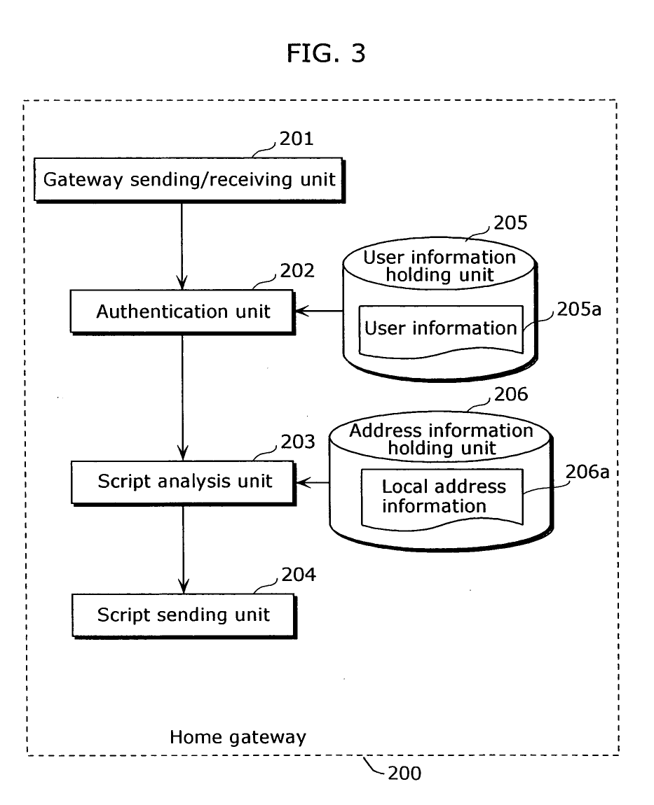

FIG. 3 is a functional block diagram showing a functional structure of the home gateway 200.

The home gateway 200 includes: a gateway sending/receiving unit 201 that sends/receives signals via the Internet 900; a user information holding unit 205 that previously holds user information 205a; an authentication unit 202 that obtains a script from the car-navi 100 via the gateway sending/receiving unit 201, and authenticates the user who has transmitted the script, with reference to the user information 205a; an address information holding unit 206 that previously holds local address information 206a; a script analysis unit 203 that obtains a script from the car-navi 100 via the gateway sending/receiving unit 201 and the authentication unit 202, and specifies, using the local address information 206a, a local address of the device for which the script is obtained; and a script sending unit 204 that sends the script to the device whose local address is specified.

Each of the TVs 291 and 292, and the air conditioners 293 and 294 executes an operation according to the script sent from the home gateway 200.

The execution support system 1 structured as above will be described in detail starting firstly from the prediction function unit 110 of the car-navi 100.

The prediction function unit 110 executes the prediction method disclosed in the Japanese Patent Application No. 2002-297304.

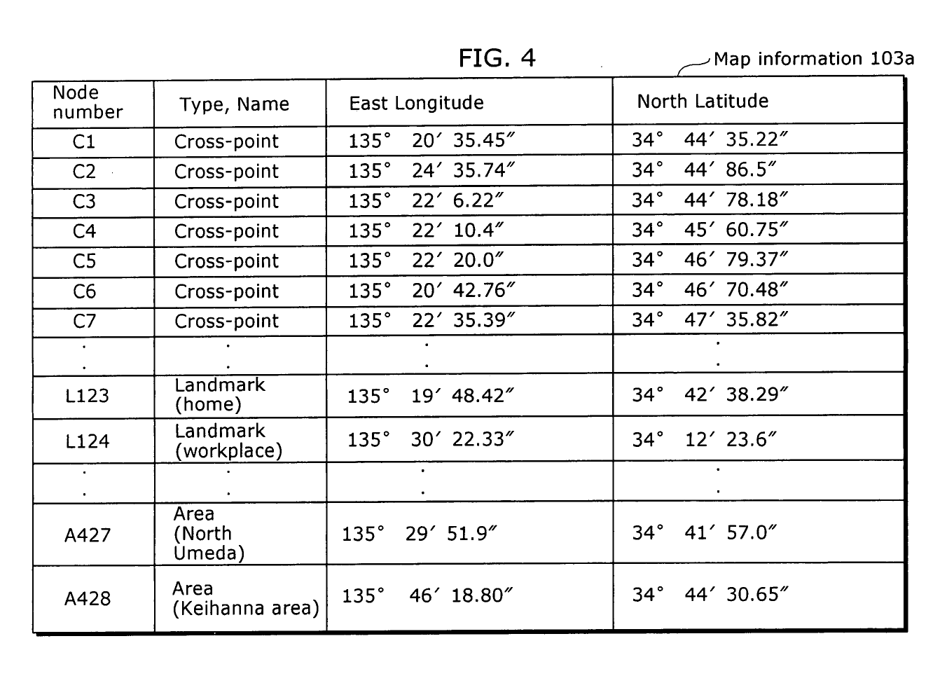

FIG. 4 is an information display diagram showing the details included in the map information 103a held by the map information holding unit 103.

A node here indicates a predetermined location and its range, for example, a predetermined cross-point, landmark or area. Besides specific locations such as “Cross-point ABC” and “DEF Amusement Park”, a “workplace” unique to the user and “Nancy's house” can be represented as nodes. A node number, that is, an identification number for identifying a node is assigned to each node.

As shown in FIG. 4, a node number, a type or a name of a node corresponding to the node number, a position indicated by longitude and latitude of a representative point of the node are registered into the map information 103a.

As for the node numbers, for example, “CXX” is assigned for cross-points, “LXX” for landmarks, and “AXX” for areas.

According to the map information 103a shown in FIG. 4, the position of each node is registered based only on longitude and latitude of the representative point of each node, however, information indicating a range (a radius with the representative point serving as a center) in accordance with the respective nodes such as cross-point, landmark, and area is also registered. For example, in the case where a node is a cross-point or a landmark, range information indicating a range defined by a radius of 10 meters with the representative point serving as a center may be registered into the map information 103a. In the case where a node is an area, range information indicating a range defined by a radius of 1 kilometer with the representative point serving as a center may be registered into the map information 103a. The range may be differently defined depending on each node. Instead of longitude and latitude, an address may be registered into the map information 103a, as a location of the node.

Note that a node number as well as a type or a name of node is registered into map information 103a, however, only a node number or a name may be registered provided that each node is identifiable.

The information (e.g. node number) that identifies a node such as a cross-point, a landmark, and an area is stored as the history information 104a into the history storage unit 104.

Note that a node may be additionally registered into or deleted from the map information 103a, according to the state in which the user drives his/her car.

For example, if the user has passed a cross-point in two or more directions while driving his/her car equipped with the car-navi 100, the cross-point is registered, as a node, into the map information 103a. When the user comes to pass the cross-point registered as a node only in one direction, during a predetermined time in the past, the node is deleted from the map information 103a. The map information 103a is not necessarily required for such node setting, and a node can be set by using only a user's history of driving.

The node judgment unit 102 searches, in the map information 103a, for the present position detected by the position detection unit 101. In the case where the present position is registered as a node into the map information 103a, the node judgment unit 102 registers a node number of the node and the time when the user passed the node, as the history information 104a, into the history storage unit 104.

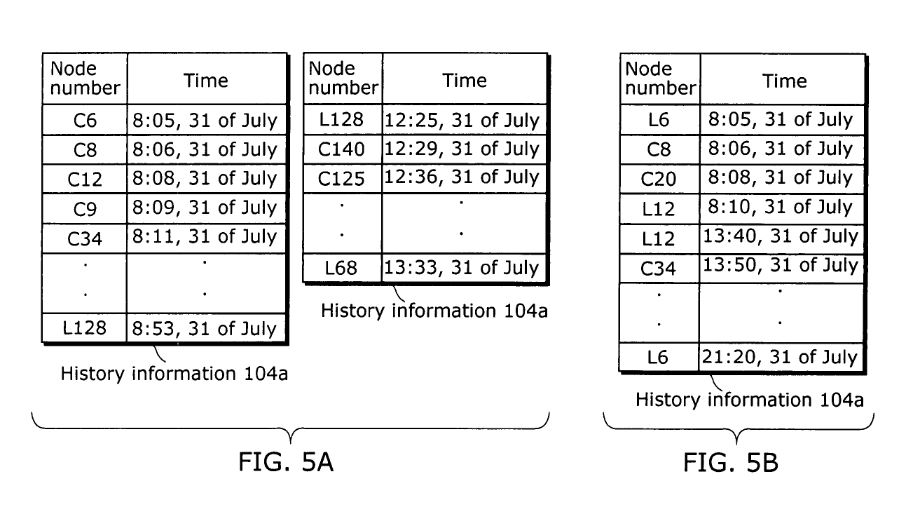

FIGS. 5A and 5B are an information display diagrams showing the details included in the history information 104a in the history storage unit 104.

As shown in FIGS. 5A and 5B, the node judgment unit 102 registers, in a chronological sequence, a node number and a passing time corresponding to the node number, as the history information 104a, into the history storage unit 104. The node judgment unit 102 registers the history information 104a into the history storage unit 104 using a predetermined segment.

FIG. 5A shows two segments of history information 104a which are respectively registered in a segment starting from the place where the user started the engine (i.e. starting point) to the place where the user stopped the engine (i.e. destination). FIG. 5B shows the history information 104a registered in a segment starting from the starting point until the user gets back to the same point.

The history information 104a shown in FIG. 5A indicates that the car started a node with the node number L6 at 8:05 am on the 31 of July, passed a node with the node number C8 at 8:06 on the same day, and then passed a node with the node number C12 on the same day.

The history information 104a shown in FIG. 5B indicates that a car started a node with the node number L6 at 8:05 am on the 31 of July, passed a node with the node number C8 at 8:06 on the same day, and returned back to the node with the node number L6 at 21:20 on the same day.

Note that the node judgment unit 102 may store the history information 104a in a segment labeled “the same day”, or without segment.

The node judgment unit 102 registers each passing time using units such as minute, hour, day and month into the history storage unit 104, however, units such as year, second, date may be registered, or any combination of such units may be registered. In the case where the history information 104a is registered in a segment using a unit of drive starting from the start of the engine until the engine stops, the node judgment unit 102 may register, into the history storage unit 104, the time when the engine is started and the time when the engine is stopped together with the node numbers. As for the node at which the user passed, only the node number may be registered. The node judgment unit 102 may register, into the history storage unit 104, not only the information related to such time but also information related to weather, a driver and fellow passengers that is included in the history information 104a.

The threshold calculation unit 105 calculates a threshold of occurrence frequency for classifying the nodes that compose the transition-state information, with reference to the history information 104a stored in the history storage unit 104. A variation of methods to calculate a threshold is provided, and the calculation may be performed based on an amount of data stored in the history storage unit 104 or on a distribution of the occurrence frequencies of all the nodes. The calculation may be performed by obtaining an average occurrence frequency of all the nodes and then multiplying a constant with the average. Any of the methods can be employed.

After a threshold is calculated by the threshold calculation unit 105, the transition-state information creation unit 106 creates transition-state information based on the respective nodes whose occurrence frequency is equal to or greater than the threshold, using the history information 104a in the history storage unit 104.

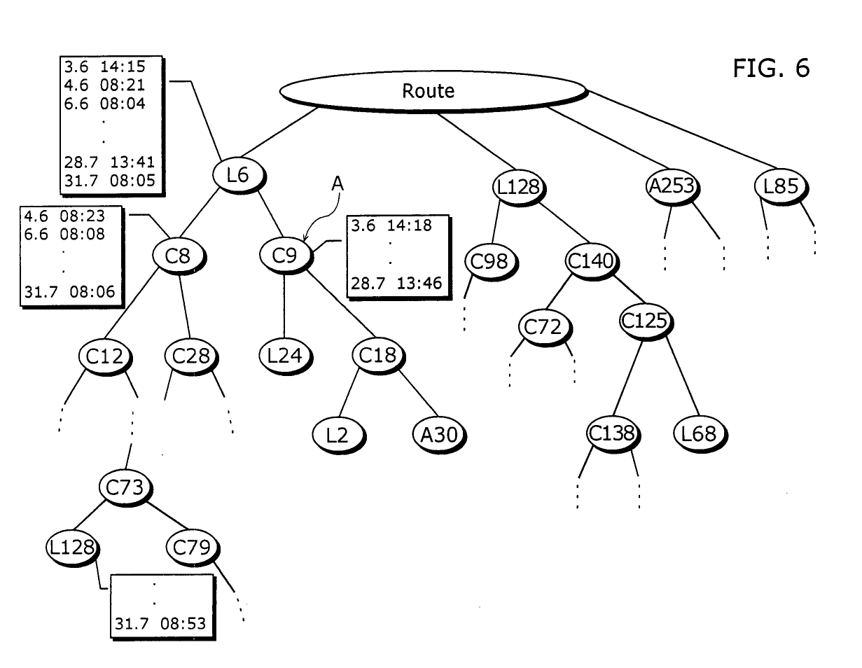

FIG. 6 is an information display diagram showing an example of the details included in the transition-state information.

As shown in FIG. 6, the transition-state information has a tree structure representing a state of transition where the node numbers L6, L128, A253 and L85, each indicating a node (i.e. starting point) such as a landmark and an area from which the user started driving, are located at the top directly below a route and are set as base points. Such transition-state information is structured so that the node numbers L128, L2 and A30, each indicating a node (i.e. destination) such as a landmark and an area at which the user stopped driving, are located in the lowest layers in each branch.

The transition-state information further includes state information (data indicated in a square in FIG. 6) indicating, for each of the node numbers, a state in which the user left, passed or arrived at the node. By using such state information, it is possible to search in the transition-state information with tree structure, using a condition such as “the nodes which the user passed in the period of time from 9:00 am until noon during the week” as a search key.

Note that the state information in the transition-state information shown in FIG. 6 includes date and time indicated by the history information 104a shown in FIGS. 5A and 5B. However, information related to driver and passengers or weather information concerning weather, temperature and probability of precipitation may be included in the state information. Such state information is registered in correspondence with each of the node numbers.

The condition determination unit 107 determines, with reference to condition tables pre-held thereby, a suitable condition to be used for the prediction performed by the prediction unit 108.

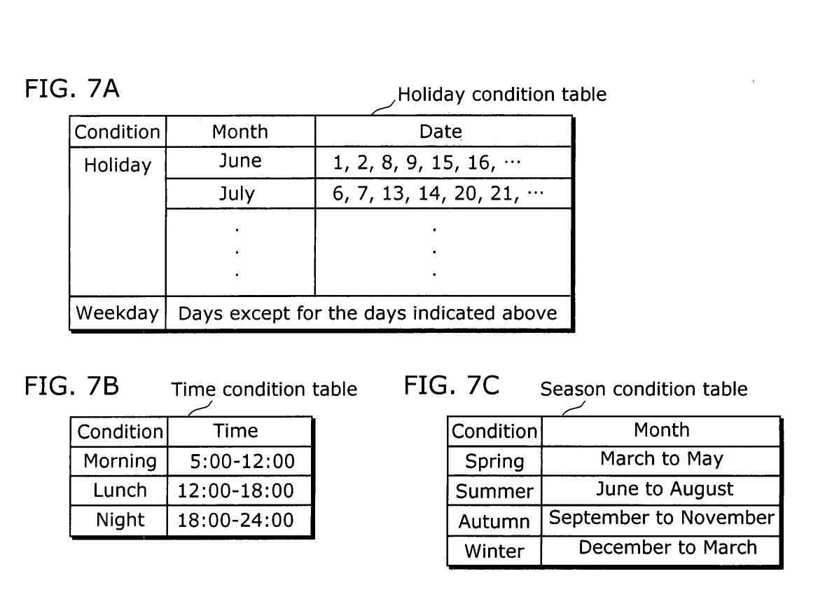

FIG. 7A is an information display diagram showing the details included in a holiday condition table that is one of the condition tables.

The holiday condition table includes information indicating when weekdays and holidays are.

That is to say, the condition determination unit 107 judges whether today is a weekday or a holiday, with reference to such holiday condition table. For example, in the case where today is judged to be a holiday, the condition determination unit 107 specifies holiday as a candidate for conditions.

FIG. 7B is an information display diagram showing the details included in a time condition table that is one of the condition tables.

The time condition table includes information respectively defining a period of time for morning, afternoon and night.

In other words, the condition determination unit 107 judges whether the present time is morning, afternoon or night, with reference to such time condition table. In the case where the present time is judged to be a night time, the condition determination unit 107 specifies night as a candidate for conditions.

FIG. 7C is an information display diagram showing the details included in a season condition table that is one of the condition tables.

The season condition table includes information respectively defining a seasonal period for spring, summer, autumn and winter.

That is to say that the condition determination unit 107 judges whether today is in spring, summer, autumn, or winter, with reference to such season condition table. In the case where today is judged to be in spring, the condition determination unit 107 specifies spring as a candidate for conditions.

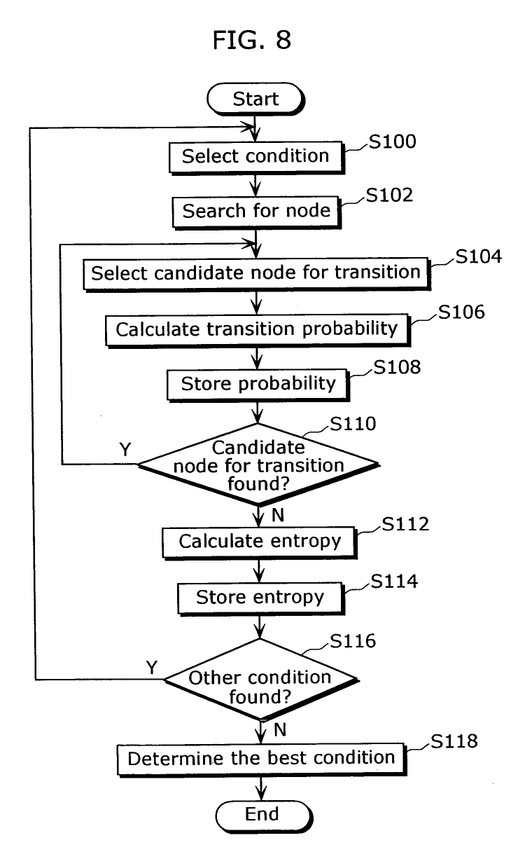

FIG. 8 is an operational flowchart showing a sequence of operations performed by the condition determination unit 107.

The condition determination unit 107 firstly obtains the information related to a state of present up to recent past, with reference to the history information 104a in the history storage unit 104. Assume here that a present position is a node with the node number C9, a starting point is a node with the node number L6, and a present time is at 14:00 on 3 of June.

The condition determination unit 107 can extract the condition such as “weekday”, “afternoon” and “summer” with reference to the holiday condition table, the time condition table and the season condition table, and select one condition, e.g., “weekday, node number C9” out of these conditions (Step S100).

The condition determination unit 107 searches for the node that meets such condition in the transition-state information (Step S102). According to the transition-state information shown in FIG. 6, a node A of the node number C9 meets the condition. The condition: determination unit 107 therefore recognizes that the node A is a node that fulfills the search condition.

Next, the condition determination unit 107 selects one node (located in the lowest layer) that may transit in the future, using the node A with the node number C9 as a base point (Step S104), calculates a probability of transition to the selected node (Step S106), and stores the calculated value (Step S108).

The following methods are provided as a method to calculate a transition probability. The transition probability P(Ln|C9) can be obtained by the following equation: P(Ln|C9)=Freq (Ln|Cond)/Freq (C9|Cond), where “Cond” denotes a condition, “Freq (C9|Cond)” denotes an occurrence frequency that the base point (node A with the node number C9) fulfills the condition “Cond” and “Freq (Ln|Cond)” denotes a frequency that the node (Ln) that may transit fulfills the condition “Cond”.

After the transition probability is thus calculated for one node, the condition determination unit 107 judges whether or not any other nodes may transit under the condition previously used (Step S110). In the case of detecting such node (Y in Step S110), the condition determination unit 107 calculates a transition probability for the node, and stores the calculated value.

In the case of not detecting such node (N in Step S110), the condition determination unit 107 calculates entropy of the transition probability under the previous condition based on the stored transition probability (Step S112), and stores the calculated value together with the condition (Step S114).

After thus storing the entropy, the condition determination unit 107 then searches for other presently-selected conditions (e.g., “weekday, node number C9, afternoon” or “weekday, transition from the node with the node number L6 to the node with the node number C9, summer) (Step S116). In the case where such condition is searched out (Y in Step S116), the condition determination unit 107 repeats the operation starting from Step S100.

In the case where such condition is not searched out (N in Step S116), the condition determination unit 107 selects a condition which is already stored and under which a value of entropy becomes the smallest, and determines it as the best condition (Step S118).

Note that the respective condition tables held by the condition determination unit 107 may have a tree structure.

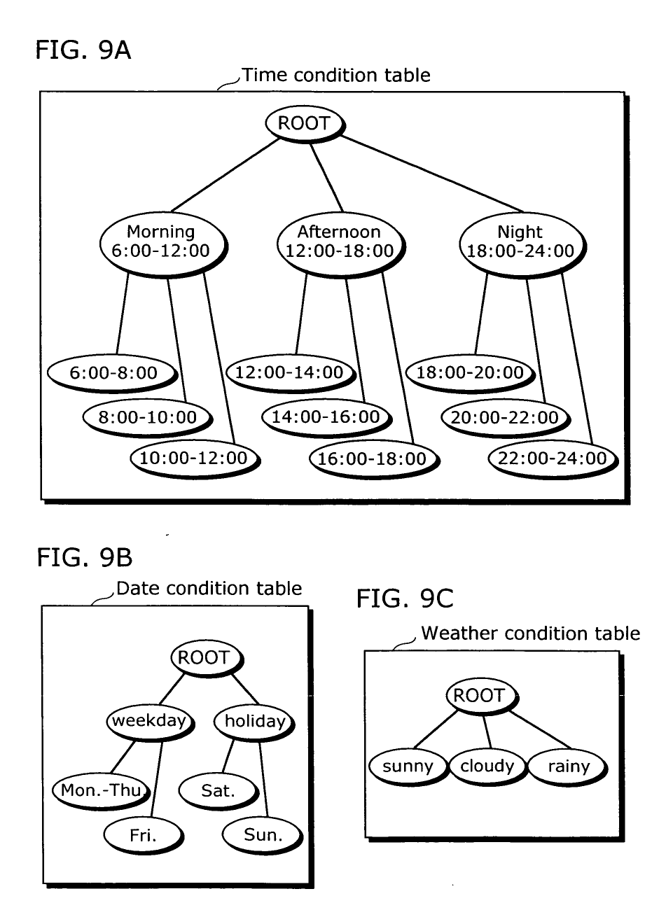

FIGS. 9A to 9C respectively shows an example of the condition table having a tree structure. FIG. 9A shows a time condition table, FIG. 9B shows a date condition table and FIG. 9C shows a weather condition table, each being one of the condition tables with tree structure.

The time condition table shown in FIG. 9A indicates the following: the conditions “from 6:00 to 8:00” “from 8:00 to 10:00” and “from 10:00 to 12:00” belong to the condition “morning”; the conditions “from 12:00 to 14:00”, “from 14:00 to 16:00” and “from 16:00 to 18:00” belong to the condition “afternoon”; and the conditions “from 18:00 to 19:59”, “from 20:00 to 21:59” and “from 22:00 to 24:00” belong to the condition “night”.

The date condition table shown in FIG. 9B indicates that the conditions “from Monday to Thursday” and “Friday” respectively belongs to the condition “weekday” while the conditions “Saturday” and “Sunday” belong to the condition “holiday”.

The weather condition table shown in FIG. 9C indicates that “sunny”, “cloudy” and “rainy” are used as conditions.

For example, assuming that the present state is “Monday”, “14:00” and “sunny”, the condition determination unit 107 determines that the present state “Monday” belongs to the condition “weekday”, with reference to the date condition table, and further determines that the present state “14:00” belongs to the condition “afternoon”, with reference to the time condition table.

The condition determination unit 107 then searches for transition-state information using the conditions “weekday”, “afternoon” and “sunny”, and determines the condition under which the entropy of the transition probability becomes the smallest. For example, assuming that the condition is “afternoon”, the condition determination unit 107 searches for transition-state information using the conditions “weekday”, “sunny” and the condition located in the layer lower than the condition “afternoon”, and determines the condition under which the entropy of the transition probability becomes the smallest. Now, assume that the condition “afternoon” turns out to be such condition, the condition determination unit 107 compares an entropy of the condition “afternoon” and entropies of the conditions “afternoon” and “working day”. In the case where the former is smaller, the condition determination unit 107 determines that the condition “afternoon” is the best condition. In the case where the latter is smaller, the condition determination unit 107 determines the best condition by repeating the same operation as described above using the conditions “sunny” and “from 14:00 to 15:00” and the condition “from Monday to Thursday” that is located in the layer lower than the condition “weekday”.

The condition tables shown in FIGS. 7 and 9 may be or may not be different depending on the user. That is to say that the holiday condition table may differ according to the holidays of each user, while the weather condition table does not differ depending on the user. The condition determination unit 107 may therefore hold a condition table for each user and a general condition table that offers the same contents to any user. For example, the condition determination unit 107 provides each user with a holiday condition table by switching between the tables, and provides all the users with a general weather condition table. The condition determination unit 107 may include a unit that obtains, when necessary, a condition table depending on the user.

After the condition determination unit 107 determines the appropriate conditions, the prediction unit 108 predicts a node to which the user is going to transit (i.e. destination), with reference to the determined conditions and the transition-state information.

As a method to predict a destination node, the following methods are provided: to determine the node with the highest prediction probability (transition probability) to be a destination node; to previously give a range to a node according to the prediction probability so as to output a value based on random numbers, and determine the node having the range to which the value belongs to be a destination node; and to determine, as destination nodes, all the nodes having a probability value that is equal to or greater than a predetermined value. Note that after the prediction of the destination node, it is naturally possible to predict a path to the predicted node by referring to the transition-state information.

The prediction unit 108 further calculates, as a time required to reach the destination, an average value of each of the times required so far for driving between the present node and the respective nodes predicted as described above, and also specifies a scheduled time for arriving at the destination, by adding the required time to the present time.

The prediction unit 108 outputs prediction result data indicating a node number of the destination node and the required time and the scheduled arrival time.

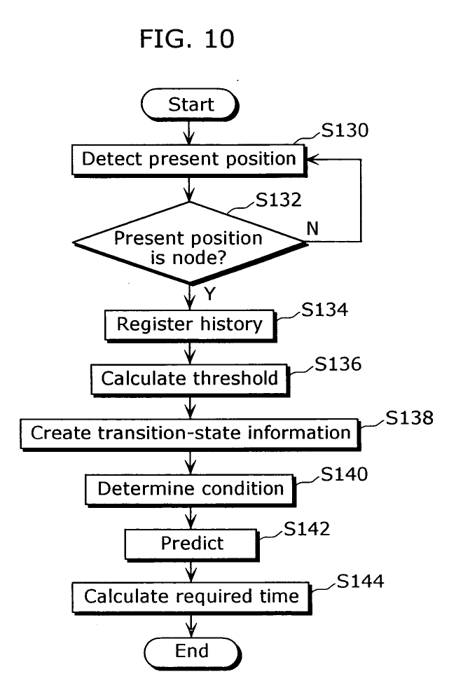

A sequence of operations performed by the prediction function unit 110 in such car-navi 100 will be described with reference to FIG. 10.

FIG. 10 is a flowchart showing the sequence of operations performed by the prediction function unit 110.

The position detection unit 101 detects a present position of the car-navi 100 (Step S130).

The node judgment unit 120 judges whether or not the present position is registered as a node, with reference to the map information 103a (Step S132).

In the case of judging that the present position is registered as a node, the node judgment unit 102 registers, as the history information 104a, a node number indicating the node as well as time and date into the history storage unit 104 (Step S134).

The threshold calculation unit 105 calculates a threshold of occurrence frequency with reference to the history information 104a (Step S136).

The transition-state information creation unit 106 creates transition-state information based on the node whose occurrence frequency equals to or greater than the threshold (Step S138).

The condition determination unit 107 determines appropriate conditions based on the transition-state information as described with reference to FIG. 8 (Step S140).

The prediction unit 108 predicts a destination node to be a destination based on the conditions determined in Step S140 (Step S142), and then further specifies a required time and a scheduled arrival time so as to output the prediction result data (Step S144).

By performing such operation, the prediction function unit 110 of the car-navi 100 predicts the destination where the car-navi 100 is heading for.

Next, the following describes a script function unit 120 of the car-navi 100.

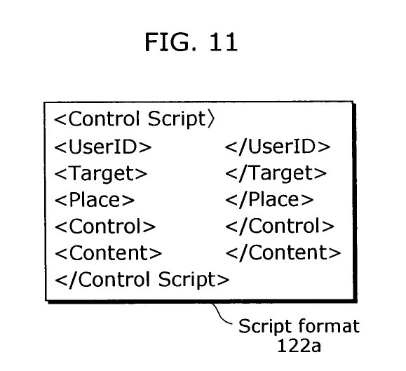

FIG. 11 is a format display diagram showing an example of the script format 122a stored in the format storing unit 122.

As shown in FIG. 11, the script format 122a is formed so that a user ID (<User ID>), a device to be controlled (<Target>), a location of the device (<Place>), control operation (<Control>) and settings required for executing the control operation (<Content>) are inputted.

The format storing unit 122 may store not only one type but plural types of such script format 122a. The script format 122a is, for example, registered from the format registration unit 121 into the format storing unit 122 based on, for instance, the operation carried out by the user using the car-navi 100.

Note that, the format registration unit 121 may obtain the script format 122a from the server, for instance, through the communication via the Internet with the server that previously holds plural types of script formats, and register it into the format storing unit 122. The format registration unit may read out the script format 122a from the memory card being a card-type data storage medium, and register the read-out script format 122a into the format storing unit 122. Thus, in the case where the format registration unit 121 registers the script format 122a into the format storing unit 122 using the Internet 900 or the memory card, the user's tasks required for the registration can be reduced.

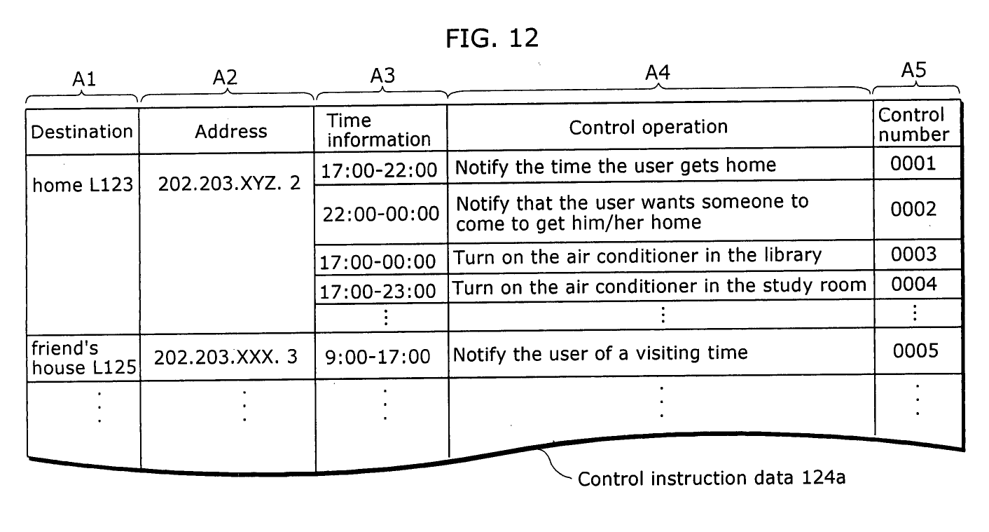

FIG. 12 is an information display diagram showing the details included in the control instruction data 124a in the control parameter storing unit 124.

As shown in FIG. 12, the control instruction data 124a has the following columns: a destination A1; an address A2; a time information A3; a control operation A4; and a control number A5. A name of destination such as user's home and his/her friend's house and its node number are registered into the destination column A1, and an address corresponding to each destination is registered into the address column A2, while an operation of each control to be performed on the devices located in the destination is registered into the control operation column A4. A period of time during which each control is performed is registered into the time information column A3, and a control number assigned for each control is registered into the control number column A5.

For example, in the case where the destination is a home place of the user operating the car-navi 100, a global address “202.203.XYZ.2” assigned to the home gateway 200 of the home place is registered in the column A2, and the control operation such as “Notify the time the user gets home”, “Notify that the user wants someone to come to get him/her” and “Turn on the air conditioner in the library” to be performed on the devices located in the home place are registered in the control operation column A4. A control number “0001” is assigned to the control operation “Notify the time when the user gets home”, while the time information “17:00-22:00” is associated with the control operation.

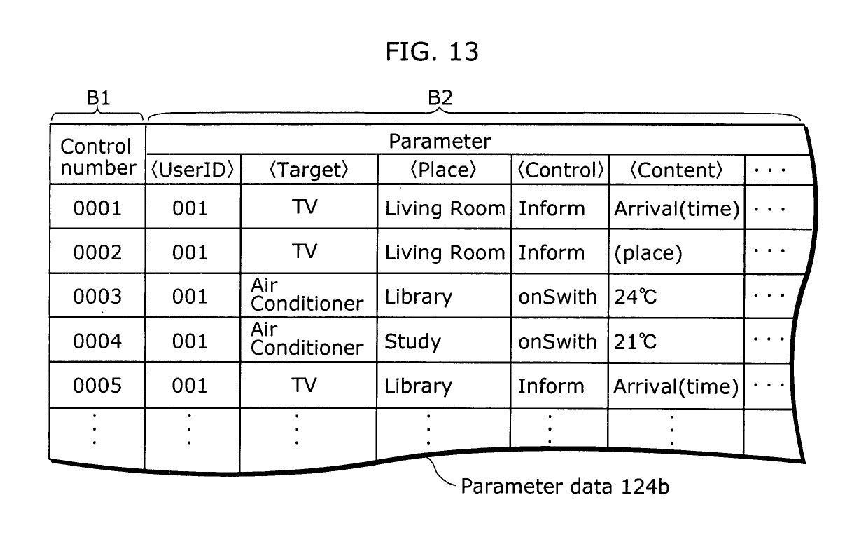

FIG. 13 is an information display diagram showing the details included in the parameter data 124b in the control parameter storing unit 124.

As shown in FIG. 13, the parameter data 124b has the following columns: a control number B1; and a parameter B2. A control number indicated in the control instruction data 124a is registered into the control number column B1, while a parameter necessary for executing the control operation corresponding to the control number is registered into the parameter column B2.

For example, the following parameters are registered in the parameter data 124b, as the parameters necessary for executing the control operation “Notify the time when the user gets home” with the control number “0001”: “0001” indicating a user ID (<UserID>); “TV” indicating a device to be controlled (<Target>); “LivingRoom” indicating a location of the device (<Place>); “Infom” indicating a control operation (<Control>); and “Arrival (time)” indicating a setting required for executing the control operation. Here, “Infom” indicates the control operation “Notify” and “Arrivial (time)” indicates a scheduled arrival time (i.e. a time to get home).

The following parameters are registered as the parameters necessary for executing the control operation “Turn on the air conditioner in the library” indicated by the control number “0003”: “001” indicating a user ID (<UserID>); “Library” indicating a location of the device (<Place>); “onSwitch” indicating a control operation (<Control>); and “24° C.” indicating a setting required for executing the control operation (<Content>). Here, “onSwitch” indicates the control operation “Turn on the device” and “24° C.” indicates the setting of “set the room temperature to be 24° C.”.

Such control instruction data 124a and the parameter data 124b are registered from the parameter registration unit 123 into the control parameter storing unit 124, for example, through the user's operations.

Having obtained the prediction result data from the prediction unit 108 of the prediction function unit 110, the script creation unit 125 searches for the control number corresponding to the destination indicated in the prediction result data, in the control instruction data 124a in the control parameter storing unit 124. The script creation unit 125 searches for the control number corresponding to the time when the prediction result data is obtained.

For example, in the case of obtaining the prediction result data indicating the destination “home, node number L123” at 20:00, the script creation unit 125 searches for the destination “home, node number L123” in the control instruction data 124a, and then searches for the control number (i.e. control operation) associated lo with the time that includes “20:00” among the control numbers corresponded to the “home, node number L123”. As a result, the script creation unit 125 specifies the control numbers “0001”, “0003” and “0004”. After having obtained the prediction result data indicating the destination “home, node number L123” at 23:00, is the script creation unit 125 searches for the destination “home, node number L123” in the control instruction data 124a, and further searches for the control number associated with the time that includes “23:00” in the control numbers corresponded to “home, node number L123”. As a result, the script creation unit 125 specifies the control numbers “0002”, “0003” and “0004”.

The script creation unit 125 refers to the parameter data 124b in the control parameter storing unit 124, extracts the parameter that corresponds to the specified control number, e.g., “001”, and inputs the extracted parameter into the script format 122a in the format storing unit 122 so as to create a script to be transmitted to the destination.

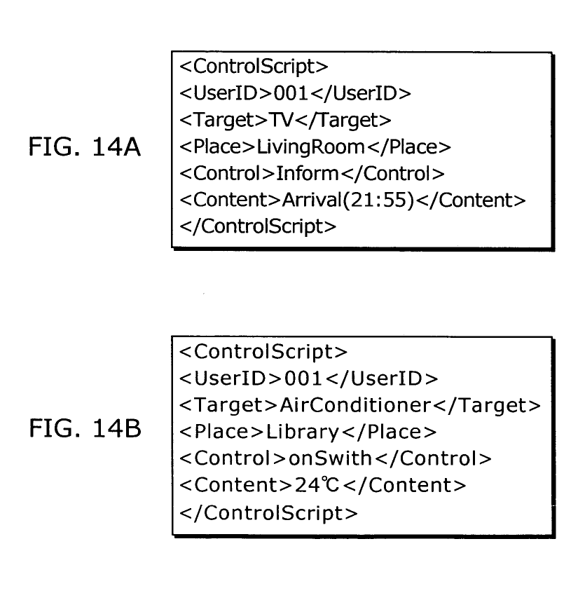

FIGS. 14A and 14B are display diagrams respectively showing an example of the script created by the script creation unit 125. FIG. 14A shows the script that corresponds to the control number “0001” while FIG. 14B shows the script that corresponds to the control number “0003”.

The script shown in FIG. 14A is created so as to allow the TV 292 set in the living room to execute the operation “Notify that the user having the user ID “001” gets home at 21:55”. The script creation unit 125 converts the “Arrival (time)” that is a parameter extracted from the parameter data 124b into “Arrival (21:55)” based on the scheduled arrival time “21:55” indicated in the prediction result data from the prediction unit 108, and inputs the converted parameter into the script format 122a.

The script shown in FIG. 14B is created so as to allow the air conditioner 293 in the living room to execute the operation “Turn the air conditioner on so that the room temperature is set to 24° C.”.

The navigation sending/receiving unit 126 obtains an address of the destination predicted by the prediction unit 108 from the control instruction data 124a via the script creation unit 125, and transmits the script thus created to the address. For example, in the case where the destination is user's home, the navigation sending/receiving unit 126 transmits a script to the home gateway 200 at home.

The following describes the operation of the home gateway 200.

Having obtained the script via the gateway sending/receiving unit 201, the authentication unit 202 of the home gateway 200 refers to the user information 205a in the user information holding unit 205, and authenticates the user who has transmitted the script.

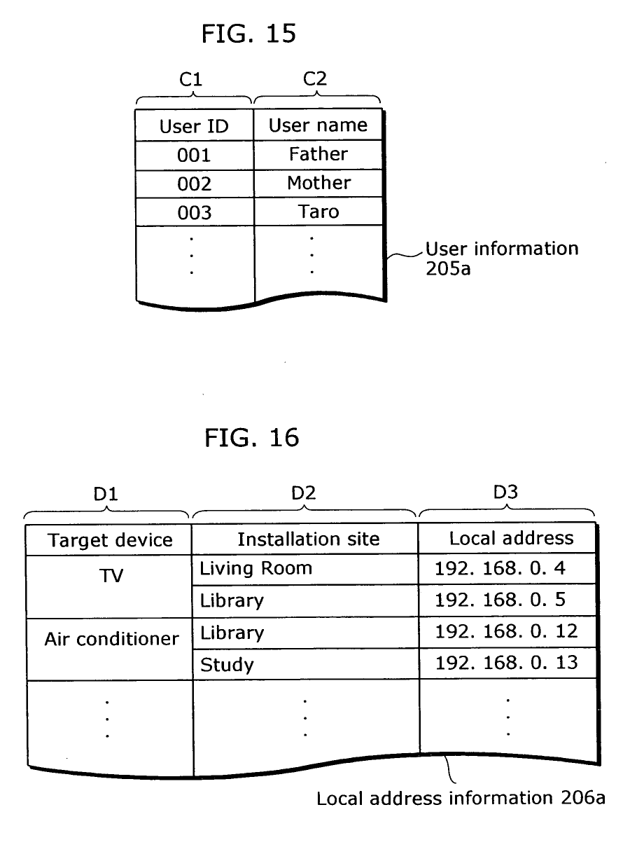

FIG. 15 is an information display diagram showing the details included in the user information 205a.

As shown in FIG. 15, the user information 205a has the following columns: a user ID C1 and a user name C2. In the user ID column C1, a user ID of a valid user is registered while in the user name column C2, a user name such as a user's nickname or a name that corresponds to the user ID is registered.

For example, the user information 205a shown in FIG. 15 indicates that the users respectively having the user IDs “001”, “002” and “003” are valid users and that a user name of the user having the user ID “001” is “Father” and a user name of the user having the user ID “002” is “Mother”.

The authentication unit 202 judges whether or not the user ID included in the obtained script is registered in the user information 205a. In the case where the user ID is registered in the user information 205a, the authentication unit 202 judges that the script is sent from a valid user, and transmits the script to the script analysis unit 203. In the case where the user ID is not registered in the user information 205a, the authentication unit 202 judges that the script is sent from an invalid user, and destroys the script. Note that the authentication method applied by the authentication unit 202 is not limited to the method based on a user ID as described above. Other method such that is based on a password of the user using the car-navi 100 or a terminal ID of the car-navi 100 may be applied instead. Encryption using, for example, Secure Sockets Layer (SSL) may be performed on the user ID and the password to be transmitted from the car-navi 100 to the home gateway 200.

Having obtained the script from the authentication unit 202, the script analysis unit 203 specifies a local address of the device targeted indicated in the script, by referring to the local address information 206a in the address information holding unit 206.

FIG. 16 is an information display diagram showing the details included in the local address information 206a.

As shown in FIG. 16, the local address information 206a has the following columns: a target device D1; an installation site D2; and a local address D3. All the types of devices connected to the home gateway 200 are registered into the target device column D1, and a location where each of the devices is set is registered into the installation site column D2, while a local address of each of the devices is registered into the local address column D3.

For example, the devices such as “TV” and “air conditioner” are registered into the target device column D1. In the installation site column D2, locations “living room” and “library” are registered in association with the device “TV” and the locations “library” and “study” are registered in association with the device “air conditioner”. The local address “192.168.0.4” is registered, into the local address column D3, in association with the target device “TV” placed in the installation site “living room”.

That is to say that, having obtained the script shown in FIG. 14A, the script analysis unit 203 specifies that a target device is a TV based on “<TargetTV</Target>” indicated in the script and that a installation site is a living room based on “<Place>LivingRoom</Place>”. The script analysis unit 203 then specifies the local address “192.168.0.4” of the device indicated in the script.

After the local address is specified, the script analysis unit 203 allows the script sending unit 204 to transmit the script to the device specified by the local address.

As a result, the device having obtained the script executes the control operation indicated in the script.

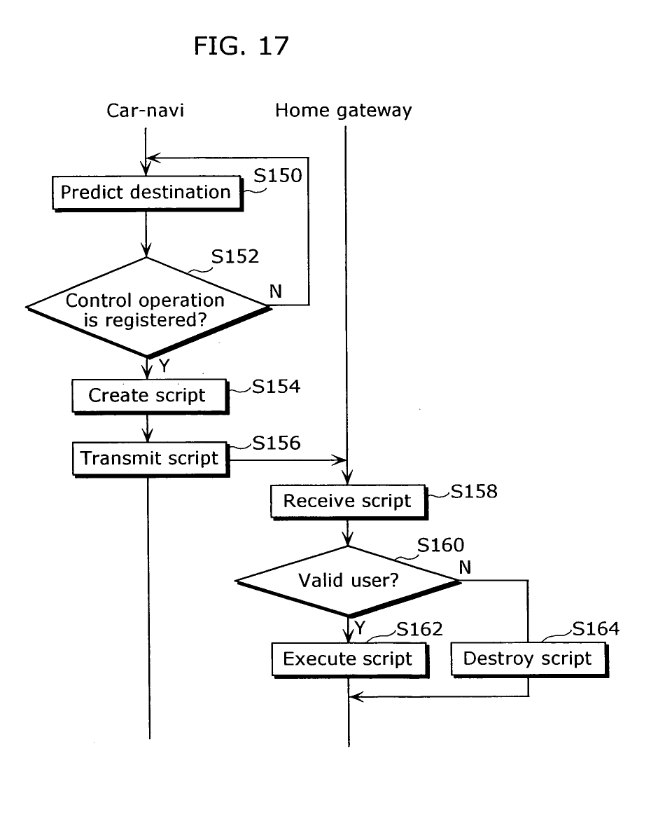

FIG. 17 is a diagram showing a sequence of the operations performed in the execution support system of the present embodiment.

The car-navi 100 firstly predicts a destination (Step S150), and judges whether or not control operation corresponded to the destination is registered, based on the reference to the control instruction data 124a (Step S152).

In the case of judging that the control operation corresponded to the destination is not registered (N in Step S152), the car-navi 100 repeats again the operation starting from Step S150, that is, the prediction of a destination. In the case of judging that the control operation corresponded to the destination is registered (Y in Step S152), the car-navi 100 creates a script indicating the control operation corresponded to the destination, using the script format 122a and the parameter data 124b (Step S154).

In the case where the destination is user's home, the car-navi 100 then transmits the created script to the home gateway 200 set at home (Step S156).

Having received the script transmitted form the car-navi 100 (Step S158), the home gateway 200 authenticates the user who has transmitted the script, based on the user ID included in the script (Step S160).

As a result, in the case of judging that the user having transmitted the script is a valid user (Y in Step S160), the home gateway 200 allows the device to execute the control indicated in the script (Step S162). In the case of judging that the user is an invalid user (N in Step S160), the home gateway 200 destroys the script (Step S164).

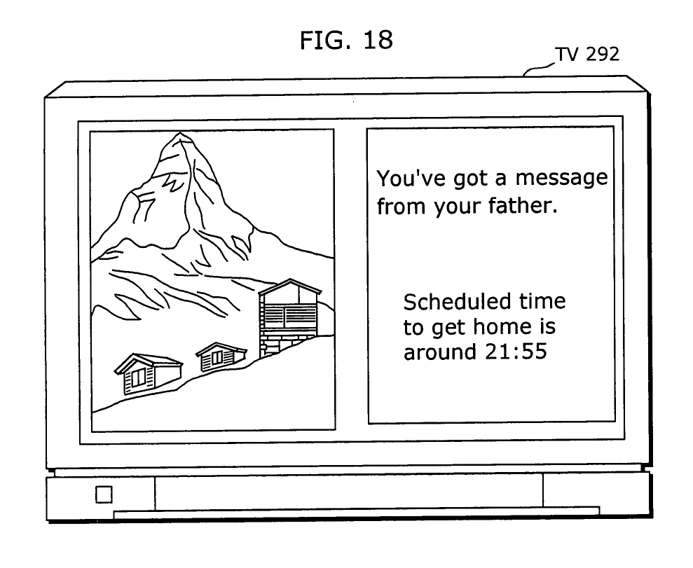

FIG. 18 is a screen display diagram showing a display of a screen on the TV 292 having executed the script.

After obtaining the script shown in FIG. 14A, the TV 292, the TV 292 executes the control operation indicated in the script, and allows the message “You've received a message from Father”. The scheduled arrival time is at 21:55.” to be displayed as shown in FIG. 18. “Father” in the message is displayed based on the user ID indicated in the script obtained by the TV 292.

Thus, in the present embodiment, the car-navi 100 predicts a destination to which it is headed, so as to allow the TVs 291 and 292 as well as the air conditioners 293 and 294 to execute the control operation indicated in the result of the prediction. The car-navi 100 can therefore support a device execute a control operation in accordance with a behavior of the user using the car-navi 100 while eliminating the cumbersome operations imposed on the user.

Note that in the present embodiment, the car-navi 100 is made to send only the script to the home gateway 200, however, the prediction result data created by the prediction unit 108 may be sent as well. In the case of receiving the script that instructs the home gateway 200 to “Turn the air conditioner on” as shown in FIG. 14B, the home gateway 200 judges whether or not the scheduled arrival time indicated in the prediction result data is the time ten minutes or more ahead from the present time. In the case of judging that the scheduled arrival time is ten minutes or more ahead from the present time, the home gateway 200 then inhibits transmission of the script to the air conditioner for a while, and transmits the script when it is ten minutes prior to the scheduled arrival time.

In this way, even in the case where the home gateway 200 receives the script from the car-navi 100, for example, one hour prior to the scheduled arrival time, it is possible to appropriately reduce the amount of electrical power consumption, without that the air conditioner idles for as long as an hour in the room without a person.

Instead of making the home gateway 200 to delay the transmission of the script, the control operation “Turn on the air conditioner in the library twenty minutes prior to the arrival” may be added to the control operation column A4 of the control instruction data 124a shown in FIG. 12 and parameters “Arrival (time)” and “20 minutes” may be registered besides the parameter “onSwitch” as the parameters necessary for executing the control. In this way, after the car-navi 100 has thus created the script indicating such control operation and has transmitted the script, the air conditioner 293 in the library receives the script via the home gateway 200, and turns the air conditioner on at the time 20 minutes prior to the arrival of the user using the car-navi 100. That is to say that the air conditioner 293 specifies the time to turn the air conditioner on based on “Arrival (time)” and “20 minutes” indicated in the script, and executes the operation at the specified time. As a result, even in the case where the air conditioner 293 receives, via the home gateway 200, the script at the time 1 hour prior to the scheduled arrival time, it is possible to appropriately reduce the amount of electrical power consumption without letting the air conditioner 293 idle for an hour in the library without a person. Moreover, it is possible to set an appropriate parameter (i.e., a time of starting up the air conditioner) what ever time the user may get home, for the parameter that changes every day, and thereby to adaptively perform control. Besides that the home gateway 200 or the air conditioner 293 to be controlled controls the timing of execution based on the script transmitted from the car-navi 100, the car-navi 100 may control the timing of the transmission of the script, while the home gateway 200 or the air conditioner 293 executes the processing as soon as it receives the script. In the above example, the time at which the air conditioner 293 is turned on is controlled based on the script, however, the time at which other device should be operated may be surely controlled.

For example, the air conditioner 293 may specify the time at which the air conditioner 293 should be turned on, based on the scheduled arrival time and a preset temperature which are indicated in the received script, and an actual room temperature, so as to execute the operation at the specified time. In such case, the parameter “Arrival (time)” may be added to the parameter data 124b as a parameter that corresponds to the control number “0003”, and a temperature sensor for detecting an actual room temperature may be set in the air conditioner 293. In the case of receiving the script that corresponds to the control number “0003”, the air conditioner 293 is turned on at the specified time based on the scheduled arrival time and the preset temperature which are indicated in the script, and the room temperature detected by the temperature sensor. That is to say that, in the case where a gap between the preset temperature and the actual temperature is large, the air conditioner 293 is turned on at the time sufficiently earlier than the scheduled arrival time, and in the case where the gap is small, the air conditioner 293 is turned on slightly earlier than the scheduled arrival time. Thus, it is possible to prevent the case where the actual temperature has not reached the preset temperature when the user operating the car-navi 100 gets home, and thereby to appropriately reduce the amount of electrical power consumption.

The air conditioner 293 may further include a function to notify the car-navi 100 of the result of the execution. For example, in the case where the air conditioner 293 is turned on with the preset temperature of 24° C. based on the script transmitted from the car-navi 100, the air conditioner 293 transmits result notification data indicating that the air conditioner 293 is turned on and that the preset temperature is 24° C., to the car-navi 100 via the home gateway 200. Having obtained such result notification data, the car-navi 100 displays the detail of the result notification data on the screen so as to notify the user of it. Thus, the user can grasp the operational state of the device indicated in the result notification data, which leads to the enhancement of the usability. Furthermore, the car-navi 100 may include a function to send an instruction so that the operational state of the device indicated in the result notification data is changed. For example, the car-navi 100 having displayed the result notification data “The air conditioner in the library is turned on. The preset temperature is 24° C.”, creates a script indicating an instruction to change the preset temperature to 26° C. according to the user's operation. The car-navi 100 transmits the script to the air conditioner 293 via the home gateway 200. Having obtained such script, the air conditioner 293 changes the preset temperature from 24° C. to 26° C. Thus, the usability can be further improved for the user. In the present embodiment, it is the car-navi 100 that predicts its destination, however, the car-navi 100 may judge whether or not the prediction is correct or incorrect. In the case of judging that the user's car is headed to a place different from a predicted destination after the transmission of the script that corresponds to the predicted destination, the car-navi 100 transmits another script indicating an instruction to cancel the control indicated in the transmitted script. For example, in the case of having transmitted the script indicating an instruction to “Turn the air conditioner on”, the car-navi 100 transmits a script indicating an instruction to “Turn the air conditioner off”. In the case of having transmitted the script indicating an instruction to “Notify user's arrival time”, the car-navi 100 transmits a script indicating an instructing to “Notify that the notified arrival time is wrong”.

In this way, it is possible to allow each of the devices to execute appropriate control even when the prediction made by the car-navi 100 is incorrect.

### Second Embodiment

The following describes the execution support system according to the second embodiment of the preset invention, with reference to the diagrams.

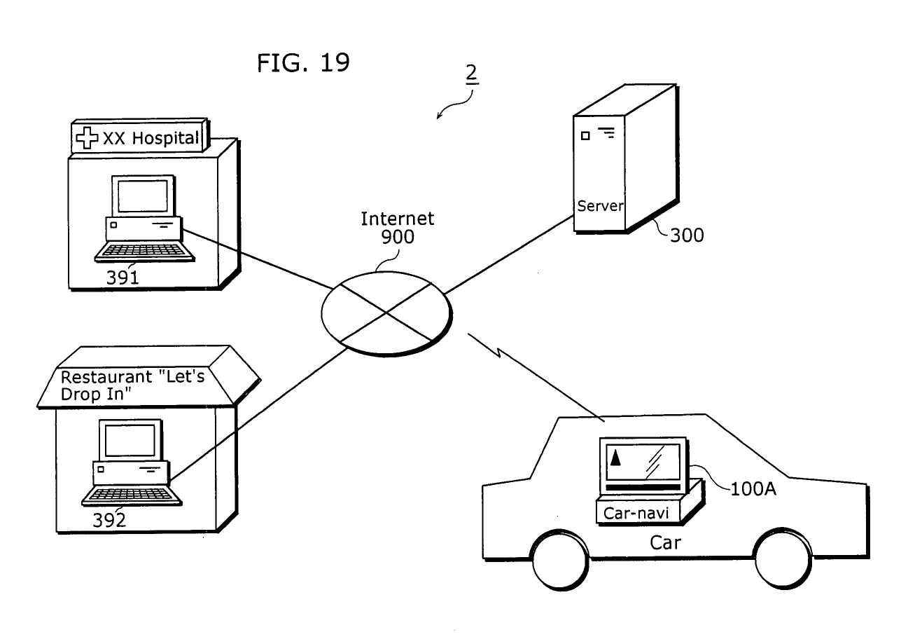

FIG. 19 is a diagram showing a structure of the execution support system of the present embodiment.

The execution support system 2 according to the present embodiment supports a device execute a control operation in accordance with the user's behavior while eliminating the troublesome operations imposed on the user, as is the case of the first embodiment. Such execution support system 2 includes: a car-navi 100A placed in the car; a hospital terminal 391 set in a hospital; a store terminal 392 placed in a restaurant; and a server 300 that communicates with the hospital terminal 391, the store terminal 392 and the car-navi 100A via the Internet 900.

Under such execution support system 2, reception services that can be accepted by the hospital terminal 391 in the hospital and the store terminal 392 in the restaurant are previously registered in the server 300 as the operations to be controlled by the hospital terminal 391 and the store terminal 392. In the case where the car-navi 100A predicts that the car is headed to the hospital, the server-300 notifies the car-navi 100A of some reception services available at the hospital terminal 391. After the car-navi 100A selects, for example, a reservation for consultation, from the presented reception services according to the user's operation, the server 300 allows the hospital terminal 391 to make a reservation for consultation. In other words, the server 300 allows the hospital terminal 391 to execute registration of the information indicating a reservation for consultation.

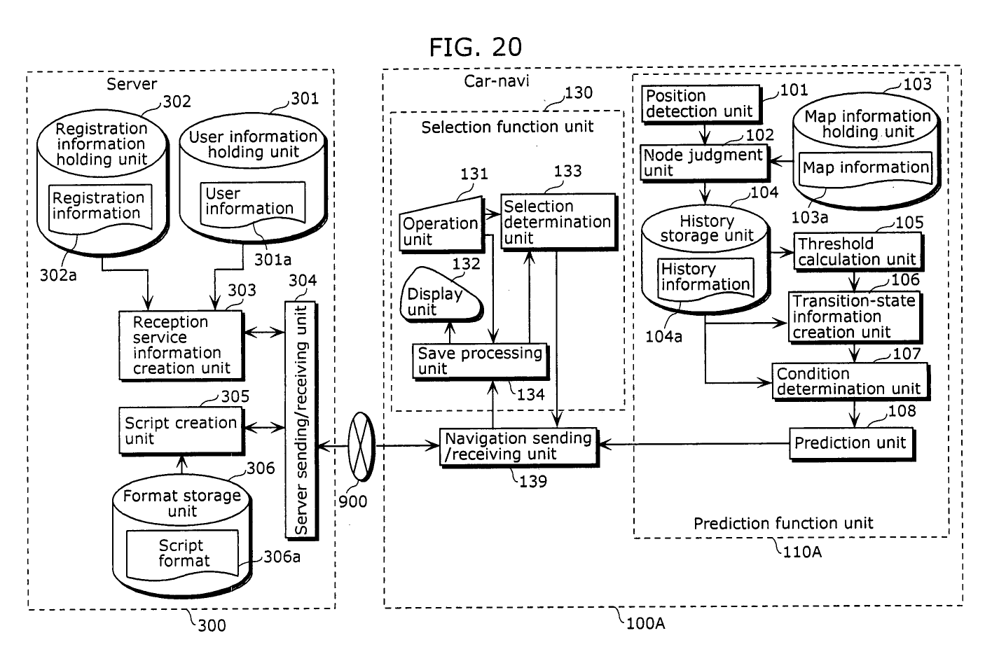

FIG. 20 is a block diagram showing functional structures of the server 300 and the car-navi 100A.

The server 300 includes the following units: a registration information holding unit 302 that previously holds registration information 302a; a user information holding unit 301 that previously holds user information 301a; a reception service information creation unit 303 that creates reception service information indicating the reception services according to the destination of the car-navi 100A, based on the registration information 302a and the user information 301a; a server sending/receiving unit 304 that sends and receives signals via the Internet 900; a format holding unit 306 that previously holds a script format 306a; and a script creation unit 305 that creates a script using the script format 306a.

The car-navi 100A includes the following units: a prediction function unit 110A that predicts a destination where the car-navi 100A is heading for; a selection function unit 130 that selects any of the reception services included in the reception service information obtained from the server 300; and a navigation sending/receiving unit 139 that sends and receives signals via the Internet 900.

The prediction function unit 110A has the same functions as the prediction function unit 110 according to the first embodiment, such as the position detection unit 101, the node judgment unit 102, the map information holding unit 103, the history storage unit 104, the threshold calculation unit 105, the transition-state information creation unit 106, the condition determination unit 107, and the prediction unit 108. Such prediction function unit 110A predicts a destination where the car-navi 100A is heading for, and allows the navigation sending/receiving unit 139 to transmit the prediction result data indicating the destination and a scheduled arrival time. The navigation sending/receiving unit 139 transmits, to the server 300, a user ID of the user operating the car-navi 100A together with the prediction result data.

The selection function unit 130 temporarily stores the reception service information from the server 300, and includes: a save processing unit 134 that performs processing based on the reception service information; a display unit 132 that displays the details indicated in the reception service information; an operation unit 131 that outputs an operation signal according to the user's operation; and a selection determination unit 133 that selects any of the reception services indicated in the reception service information, according to the operation signal from the operation unit 131.

The hospital terminal 391 in a hospital and the store terminal 392 in a restaurant obtain the script so as to execute the control indicated in the script.

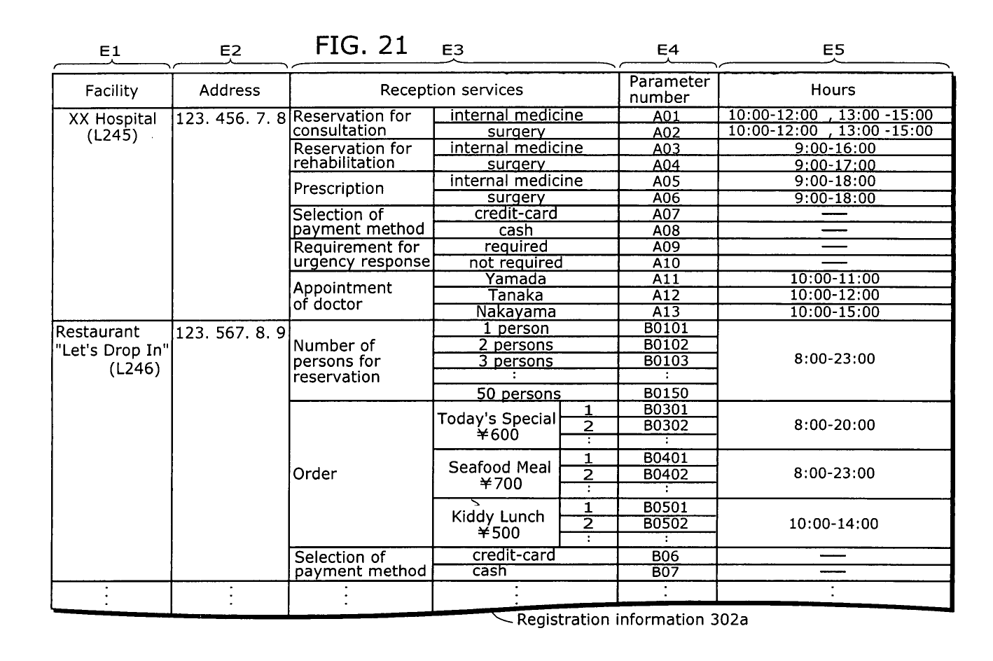

FIG. 21 is an information display diagram showing the details included in the registration information 302a held in the registration information holding unit 302.

The registration information 302a indicates reception services that can be accepted by the terminals placed in each of the facilities such as the hospital terminal 391 in the hospital and the store terminal 392 in the restaurant. Such registration information 302a has the following columns: a facility E1; an address E2; a reception service E3; a parameter number E4; and an hours column E5. A name of facility and its node number are registered into the facility column E1, and an address of the terminal placed in the facility is registered into the address column E2, while reception services are registered into the reception service column E3. A parameter number assigned to each of the reception services are registered into the parameter number column E4 while a period of time during which each reception services can be accepted is registered into the hours column E5.

For example, in the registration information 302a, a name of facility and its node number “XX Hospital, node number L245” as well as an address “123.456.7.8” of the hospital terminal 391 set in the hospital is registered. The items like “reservation for consultation” “reservation for rehabilitation” and “receiving a prescription” are also registered as the reception services accepted by the hospital terminal 391. In the case where the hospital terminal 391 also receives “reservation for consultation” for “internal medicine” and “surgery” separately, “internal medicine” or “surgery” is registered in association with “reservation for consultation”.

A parameter number “A01” is registered for the reception service “reservation for consultation/internal medicine” while a parameter number “A02” is registered for the reception service “reservation for consultation/surgery”.

In the case where the hospital terminal 391 receives the reception service “reservation for consultation/internal medicine” during the hours “10:00-12:00” and “13:00-15:00”, such hours are registered in association with “reservation for consultation/internal medicine”.

Such information related to “XX Hospital” is registered into the registration information 302a held in the registration information holding unit 302, through the operations carried out by the hospital terminal 391 via a connection with the server 300.

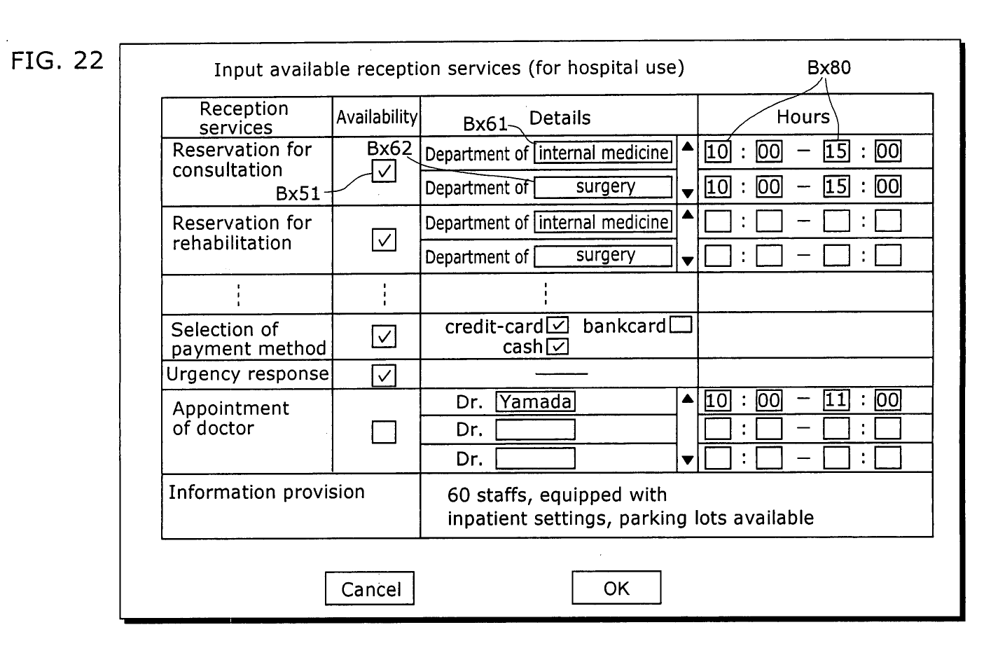

FIG. 22 is a screen display diagram showing an example of the screen of the hospital terminal 391 in the case where the information related to the hospital is registered into the registration information 302a.

For example, after a manager of the hospital connects the hospital terminal 391 to the server 300 by operating the hospital terminal 391 so as to input a name of the hospital, the server 300 allows the hospital terminal 391 to display the screen as shown in FIG. 2. On the screen, some of the candidates for reception services are displayed.

The manager then selects, from the candidates, the reception services that can be accepted by the hospital terminal 391, by operating the hospital terminal 391. For example, in the case where the reception service “reservation for consultation” can be accepted, a check box Bx51 is ticked. The medical fields of consultation are inputted into input boxes Bx61 and Bx62, and the reception hours of the reception service “reservation for consultation” performed in the respective medical departments are inputted into an input box Bx80.

For other information to be provided from the server 300 to the car-navi 100A, the manager inputs information such as “60 staffs, equipped with inpatient settings, parking lots available”. When the button “OK” is selected, the details inputted on the screen are registered into the registration information 302a.

In such registration information 302a, a name of the facility “Let's Drop In”, its node number “L246”, an address “123.567.8.9” of the store terminal 392 set in the restaurant, and the reception services that the restaurant accepts such as “number of persons for reservation”, “order” and “selection of payment method” are registered. In the case where the store terminal 392 accepts from 1 person up to 50 persons for “number of persons for reservation”, “1 person”, “2 persons” . . . “50 persons” are registered in association with “number of persons for reservation”.

The parameter number “B0101” is registered for the reception service “number of persons for reservation/1 person” while the parameter number “B0103” is registered for the reception of “number of persons for reservation/3 persons”.

In the case where the store terminal 392 accepts the reception service of “number of persons for reservation” during the hour “8:00-23:00”, such hour is registered in association with the reception of “number of persons for reservation”.

Such information related to the “restaurant ‘Let's Drop In’” is registered into the registration information 302a held in the registration information holding unit 302, by operating the store terminal 392 via a connection with the server 300.

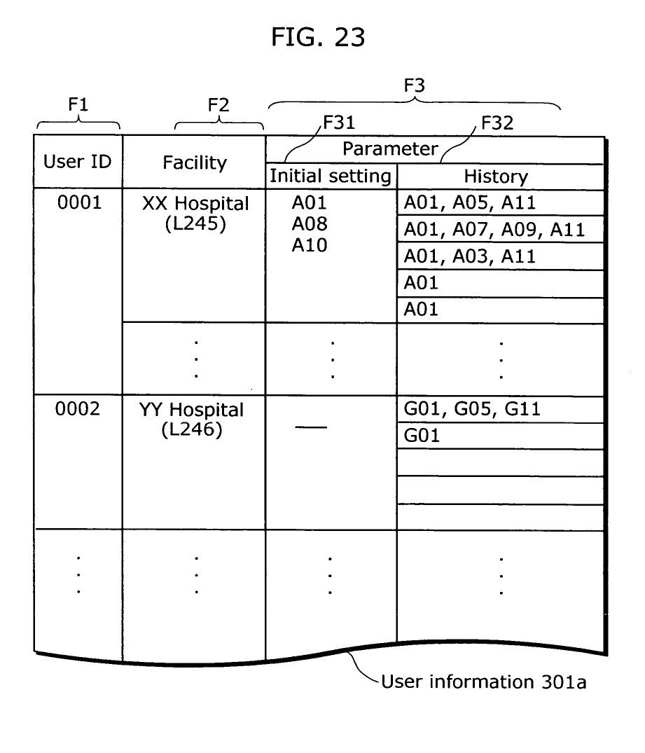

FIG. 23 is an information display diagram showing the contents included in the user information 301a held in the user information holding unit 301.

The user information 301a indicates a history of the reception services accepted through the selection as well as preset reception services. Such user information 301a has the following columns: a user ID F1; a facility F2, and a parameter number F3. The parameter number column F3 further includes an initial setting F31, and a history F32. A user ID of the user operating the car-navi 100A is registered into the user ID column F1, and a name of the facility and its node number are registered into the facility column F2 in association with the user ID, while the respective parameter numbers are registered into the initial setting columns F31 and the history column F32 in the parameter number column F3. The parameter numbers are registered in a chorological order into the column F32. In other words, the parameter numbers of the utilized reception services are registered in such a manner that the closer the time when the service is provided is to the present time, the higher the parameter number is located.

For example, a user ID “0001”, the name of the facility that corresponds to the user ID and its node number “XX Hospital, node number L245”, the parameter numbers “A01, A08 and A10” of the reception services that are preset for the user ID and the facility, and the parameter numbers “A01, A05 and A11, . . . ”, and the reception services utilized in the past with regard to the user ID and the facility are registered into the user information 301a.

That is to say that the user information 301a indicates that the user having the user ID “0001” previously sets “reservation for consultation at department of internal medicine”, “selection of payment method” and “emergency response is not required” for the reception services at the “XX Hospital”, and has utilized the services of the reception such as “reservation for consultation at department of internal medicine”, “receiving medical prescription at department of internal medicine” and “appointing Dr. Yamada” in the past.

Having obtained the prediction result data and the user ID from the car-navi 100A via the server sending/receiving unit 304, the reception service information creation unit 303 extracts, from the registration information 302a, the reception services which are available at the destination indicated in the prediction result data and at the time when the prediction result data is obtained. The reception service information creation unit 303 creates reception service information based on the extracted reception services in such a manner that a priority of the reception service, whose parameter number is registered in association with the user ID obtained from the car-navi 100A into the user information 301a, gets higher.

Namely, the reception service information creation unit 303 judges whether or not the user ID obtained from the car-navi 100A and the destination (node number) indicated in the prediction result data are registered in association with the user information 301a. In the case of judging that they are associated with each other, the reception service information creation unit 303 searches for the parameter number that is registered in association with the user ID and the destination (node number) in the initial setting column F31 and the history column F32. In the case where the parameter number is registered in the initial setting column F31 and the history column F32, the reception service information creation unit 303 creates reception service information so that the priority of the reception service corresponding to the parameter number gets high.

The reception service information creation unit 303 creates reception service information in such a manner that a priority of the reception service whose parameter number is registered into the initial setting column F31 is higher than a priority of the reception service whose parameter number is registered into the history column F32, and also that a priority of the reception service with the parameter number, whose recent occurrence frequency is the highest among the reception services of the parameter numbers registered in the history column F32, gets higher.

For example, having obtained, from the car-navi 100A, the prediction result data indicating the destination “node number L245” and the user ID “0001”, the reception service information creation unit 303 extracts, from the registration information 302a, the reception services available at the destination “node number L245”, that is, the facility “XX Hospital”. The reception creation unit 303 then refers to the user information 301a so as to search in the initial setting column F31 and the history column F32, for the parameter numbers associated with the user ID “0001” and the destination “node number L245”. The initial setting column F31 includes the parameter numbers “A01, A08 and A10” and the history column F32 includes the parameter numbers “A01 and A11” whose recent occurrence frequency is high. The reception service information creation unit 303 therefore creates reception service information so that a high priority is given to the reception services such as “reservation for consultation at department of internal medicine”, “selection of payment method” and “emergency response is not required” among the extracted reception services available in the “XX Hospital” and a secondly high priority is given to the reception service “appointing Dr. Yamada”.

Then, the reception service information creation unit 303 allows the server sending/receiving unit 304 to transmit the created reception service information to the car-navi 100A.

Having obtained the reception service information from the server 300 via the navigation sending/receiving unit 139, the save processing unit 134 of the car-navi 100A temporarily stores the reception service information and analyzes the reception services and their priorities indicated in the reception service information. Then, the save processing unit 134 allows the display unit 132 to display in such a manner that the reception service with higher priority is selected.

The selection determination unit 133 obtains the reception service information from the save processing unit 134, and also selects, from among the reception services indicated in the reception service information, the reception service indicated in the operation signal sent from the operation unit 131, and then allows the navigation sending/receiving unit 139 to transmit the result of the selection to the server 300.

That is to say, the user operating the car-navi 100A looks at several reception services displayed by the display unit 132 and specifies some of them by operating the operation unit 131.

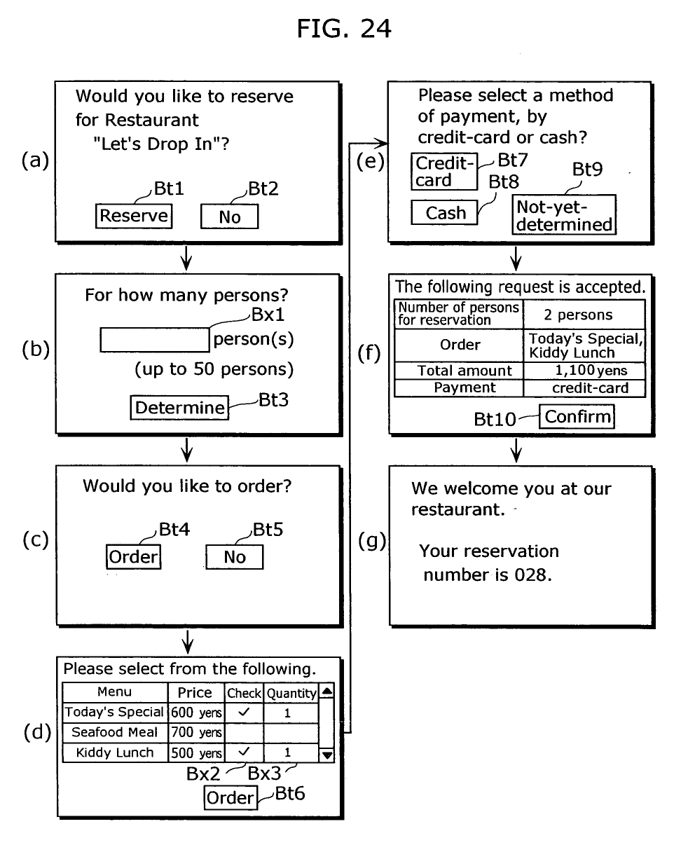

FIGS. 24(a) through 24(g) are screen display diagrams for describing screens to be displayed by the display unit 132.

The following describes the case where the reception services such as “number of persons for reservation”, “order”, and “selection of payment method” with regard to the name of the facility “restaurant ‘Let's Drop In’” are included in the reception service information.

Since the reception process “number of persons for reservation” is included in the reception service information, the save processing unit 134 firstly allows the display unit 132 to display the screen for inquiring whether or not a reservation is required.

As shown in FIG. 24(a), the display unit 132 displays a message that goes “Do you make a reservation at the restaurant ‘Let's Drop In’?”, a reservation button Bt1 on which “Reserve” is indicated, and a cancel button Bt2 on which “No” is indicated.

When the reservation button Bt1 is selected through the user's operation operating the operation unit 131, the save processing unit 134 allows the display unit 132 to display a screen for inquiring on the number of persons for reservation.

As shown in FIG. 24(b), the display unit 132 displays a message “For how many persons?”, a number input box Bx1 for inputting the number of persons, and a determination button Bt3 on which “Determine” is indicated.

When the determination button Bt3 is selected through the user's operation operating the operation unit 131 for inputting “2” into the number input box Bx1, the selection determination unit 133 selects “number of persons for reservation/2 persons” among the reception services included in the reception service information from the server 300, and temporarily stores the result of the selection.

Next, the save processing unit 134 firstly allows the display unit 132 to display a screen for inquiring on whether or not an order needs to be made, since the reception service information includes the reception service “order”.

As shown in FIG. 24(c), the display unit 132 displays a message “Would you like to order?”, an order button Bt4 on which “Order” is indicated, and a cancel button Bt5 on which “No” is indicated.

When the order button Bt4 is selected through the user's operation operating the operation unit 131, the save processing unit 134 allows the display unit 132 to display a screen for inquiring an order.

As shown in FIG. 24(b), the display unit 132 displays menus such as “Today's Special 600 yens”, “Seafood Meal 700 yens”, and “Kiddy Lunch 500 yens” as well as a check box Bx2 for selecting whether or not to order each of the menus and a number input box Bx3 for inputting a quantity for each menu. The display unit 132 also displays an order button Bt6 on which “Order” is indicated.

The user ticks the check box Bx2 that corresponds to the menu “Today's Special”, inputs “1” into the number input box Bx3, ticks the check box Bx2 that corresponds to the menu “Kiddy Lunch”, inputs “1” into the number input box Bx3, and selects the order button Bt6.

In this way, the selection determination unit 133 selects “order/Today's Special/1” and “order/Kiddy Lunch/1” from among the reception services included in the reception service information obtained from the server 300, and temporarily saves the selection.

Next, the save processing unit 134 allows the display unit 132 to display a screen for inquiring on the method of payment since the reception service information includes the reception service “selection of payment method”.

As shown in FIG. 24(e), the display unit 132 displays a message “Please select a method of payment, by credit-card or cash.”, a credit-card button Bt7 on which “Credit-card” is indicated, a cash button Bt8 on which “Cash” is indicated, and a not-yet-determined button Bt9 on which “Not-yet-determined” is indicated.

When the credit-card button Bt7 is selected through the user's operation operating the operation unit 131, the selection determination unit 133 selects “payment method/credit-card” from among the reception services included in the reception service information obtained from the server 300, and temporarily saves the selection.

Next, the save processing unit 134 allows the display unit to display all the information temporarily saved through the selection made by the selection determination unit 133.

As shown in FIG. 24(f), the display unit 132 displays “2 persons” for the number of persons for reservation, “Today's Special/1” and “Kiddy Lunch/1” as the ordered menus, “1100 yens” as a total amount of payment, “credit-card” as a method of payment, and a confirmation button Bt10 on which “Confirm” is indicated.

When the user selects the confirmation button Bt10 through the operation on the operation unit 131, the selection determination unit 133 transmits, from the navigation sending/receiving unit 139 to the server 300, all the reception services temporarily saved so far, that is, the result of the selection made by the selection determination unit 133.

As shown in FIG. 24(g), the save processing unit 134 then allows the display unit 132 to display a message “We welcome you at our restaurant. Your reservation number is 028.”. The number “028” included in the message is a number assigned by the server 300. That is to say that, the server 300, having obtained the selection result from the car-navi 100A, assigns, for each destination, a reservation number in an order of obtaining the selection result and notifies the car-navi 100A of the number.

Thus, the car-navi 100A selects a reception service, and notifies the server 300 of the selection. For example, in the case where a parameter number “B0102” indicating “number of persons for reservation/2 persons” is registered into the initial setting column F31 in the user information 301a, or the parameter number “B0102” is frequently registered into the history column F32 in the user information 301a, the reception service information creation unit 303 in the server 303 creates reception service information based on such user information 301a and transmits the created reception service information to the car-navi 100A. The save processing unit 134 in the car-navi 100A allows the display unit 132 to display “2” in the number input box Bx1 as shown in FIG. 24(b). That is to say that reception service information is created so that a priority of the reception service with the parameter number “B0102” gets higher, and the save processing unit 134 in the car-navi 100A allows the display unit 132 to display the reception service in such a manner that the reception service “number of persons for reservation/2 persons” is easily selected.

For example, in the case where a parameter number “B0301” indicating “order/Today's Special/1” is frequently registered into the history column F32 of the user information 301a, the reception service information creation unit 303 in the server 300 creates reception service information so that a priority of the reception service “order/Today's Special/1” gets higher. Therefore, the save processing unit 134 in the car-navi 100A allows the display unit 132 to firstly display “Today's Special” on the screen of the display unit 132 as shown in FIG. 24(d). Namely, the save processing unit 134 in the car-navi 100A allows the display unit 132 to display the reception service “order/Today's Special/1” with the parameter number “B0301” in such a manner that the reception service “order/Today's Special/i” with the parameter number “BO301” is easily selected. The present system thus operates based on a history of the accepted reception services, and therefore has a learning function.

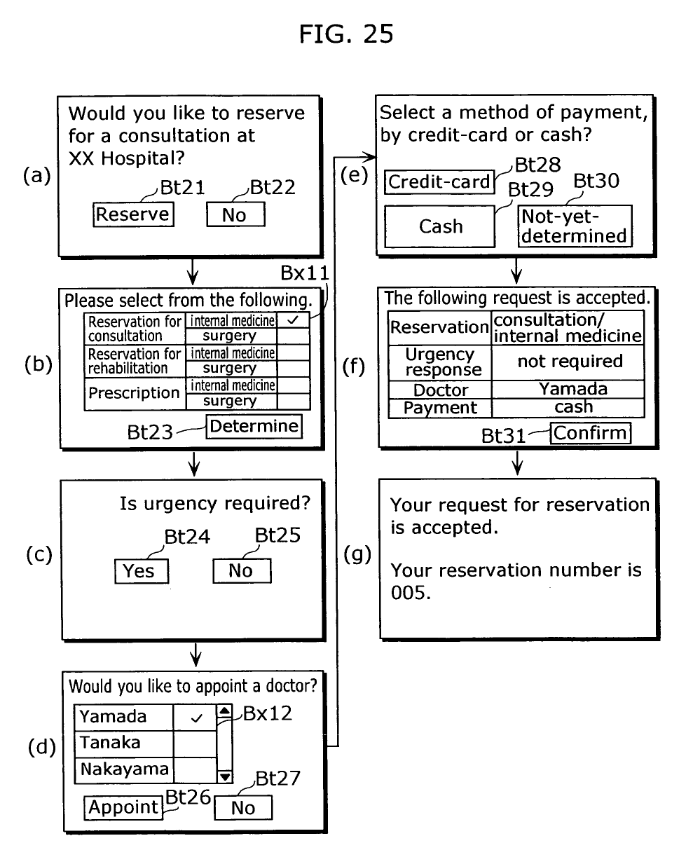

FIGS. 25(a) through 25(g) are screen display diagrams for describing other screens to be displayed by the display unit 132.

The following describes the case where reception services which are related to the name of facility “XX Hospital”, such as “reservation for consultation” “reservation for rehabilitation”, “receiving medical prescription”, selection of payment method”, “requirement for emergency response” and “appointment of doctor”, are included in the reception service information.

As the reception service information includes the reception service “reservation for consultation” and others, the save processing unit 134 allows the display unit 132 to firstly display a screen for inquiring on whether or not a reservation needs to be made.

As shown in FIG. 25(a), the display unit 132 displays a message “XX Hospital, Do you make a reservation?”, a reservation Bt21 on which “Reserve” is indicated, and a cancel button Bt22 on which “No” is indicated. As described in FIG. 22, in the case where information such as “60 staffs, equipped with inpatient settings, parking lots available” is registered in the server 300 by a manager of the hospital, such information may be displayed on the screen as shown in FIG. 25(a).

When the reservation button Bt 21 is selected through the user's operation operating the operating unit 131, the save processing unit 134 allows the display unit 132 to display a screen for inquiring on the details of the reservation.

As shown in FIG. 25(b), the display unit 132 displays the items for reservation such as “consultation, internal medicine/surgery”, “rehabilitation, internal medicine/surgery”, “prescription, internal medicine/surgery”, a selection check box Bx11 for selecting whether or not a reservation is required for each of the items, and a determination button Bt23 on which “Determine” is indicated.

When the selection check button Bx11 that corresponds to the item “consultation, internal medicine/surgery” is ticked through the user's operation operating the operation unit 131 and the confirmation button Bt23 is selected, the selection determination unit 133 selects “consultation, internal medicine” among the reception services included in the reception service information from the server 300, and temporarily save the result of the selection.

Next, since the reception service information includes the reception service “requirement for urgency response”, the save processing unit 134 allows the display unit 132 to display a screen for inquiring on whether or not urgency response is required.

As shown in FIG. 25(c), the display unit 132 displays a message “Urgency is required?”, an urgency button Bt24 on which “Yes” is indicated, and a urgency non-required button Bt25 on which “No” is indicated.

When the urgency non-required button Bt25 is selected through the user's operation operating the operation unit 131, the selection determination unit 133 selects “urgency response is not required” from among the reception services included in the reception service information from the server 300, and temporarily saves the result of the selection.

Since the reception service “appointment of doctor” is included in the reception service information, the save processing unit 134 inquires on whether or not to appoint a doctor, and allows the display unit 132 to display a screen for inquiring on the doctor to be appointed.

As shown in FIG. 25(d), the display unit 132 displays doctors' names such as “Yamada”, “Tanaka” and “Nakayama”, a check box Bx12 for inputting a name of the doctor to be appointed, an appointment button Bt26 on which “Appoint” is indicated, and a non-selection button Bt27 on which “No” is indicated.

When the check box Bx12 that corresponds to Dr. Yamada is ticked through the user's operation operating the operation unit 131, and the selecting button Bt26 is selected, the save processing unit 134 selects “appointment of doctor/Yamada” from among the reception services included in the reception service information from the server 300, and temporarily saves the result of the selection.

Since the reception service information includes the reception service “selection of payment method”, the save processing unit 134 allows the display unit 132 to display a screen for inquiring on a method of payment.

As shown in FIG. 25(e), the display unit 132 displays a message “Please select a method of payment, by credit-card or cash.”, a credit-card button Bt28 on which “Credit-card” is indicated, a cash button Bt29 on which “Cash” is indicated, and a not-yet-determined button Bt30 on which “Not-yet-determined” is indicated.

When the cash button Bt29 is selected through the user's operation operating the operation unit 131, the selection determination unit 133 selects “payment method/cash” from among the reception services included in the reception service information obtained from the server 300, and temporarily saves them.

The save processing unit 134 then allows the display unit 132 to display all the information temporarily saved through the selection made by the selection determination unit 133.

As shown in FIG. 25(f), the display unit 132 displays “consultation/internal medicine” for reservation, “not required” for urgency response, “Yamada” for doctor's name, “cash” for payment method, as well as a confirmation button Bt31 on which “Confirm” is indicated.

When the confirmation button Bt31 is selected through the user's operation operating the operation unit 131, the selection determination unit 133 transmits, from the navigation sending/receiving unit 139 to the server 300, all the reception services temporarily saved so far, that is, the result of the selection made by the selection determination unit 133.

As shown in FIG. 25(g), the save processing unit 134 allows the display unit 132 to display a message “The reservation is accepted. Your reservation number is 005.”.

For example, in the case where a parameter number “A01” indicating “reservation for consultation/internal medicine” is registered into the initial setting column F31, or the parameter number “A01” is frequently registered into the history column F32 in the user information 301a, the reception service information creation unit 303 in the server 300 creates reception service information so that a priority of the reception service “reservation for consultation/internal medicine” gets higher. Therefore, the save processing unit 134 of the car-navi 100A allows the display unit 132 to firstly display “consultation/internal medicine”, and the check box Bx11 corresponding to “consultation/internal medicine” that is already ticked.

For example, in the case where a parameter number “A11” indicating “appointment of doctor/Yamada” is frequently registered into the history column F32 of the user information 301a, the reception service information creation unit 303 creates reception service information so that a priority of the reception service “appointment of doctor/Yamada” gets higher. Therefore, the save processing unit 134 in the car-navi 100A allows the display unit 132 to firstly display “Yamada”, and the check box Bx12 corresponding to “Yamada” that is already ticked.

Thus, the user operating the car-navi 100A can easily select reception services, which leads to the enhancement of the usability. The display unit 132 of the car-navi 100A may display all the reception services respectively having a parameter number registered into the initial setting column F31 of the user information 301a. In this case, it is possible for the user to more easily select the reception service that is previously set, by pressing the confirmation button.

Note that with a speech recognizing function equipped in the car-navi 10A, the selection of buttons such as a confirmation button and a determination button may be operated by inputting user's voice.

The script creation unit 305 in the server 300 obtains the result of the selection and the user ID from the car-navi 100A via the server sending/receiving unit 304. The script creation unit 305 then creates a script by inputting, as parameters, the reception services selected by the car-navi 100A, the user ID, the scheduled arrival time indicated in the prediction result data, into a script format 306a held in the format holding unit 306. The script creation unit 305 also updates the parameter numbers registered into the history column F32 of the user information 301a held in the user information holding unit 301, based on the reception services selected by the car-navi 100A.

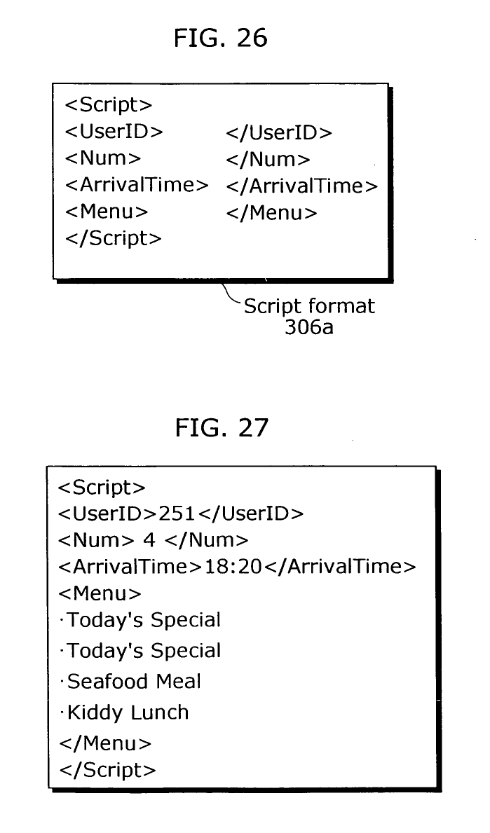

FIG. 26 is a diagram showing an example of the script format 306a held in the format holding unit 306.

As shown in FIG. 26, the script format 306a is formed so that a user ID (<User ID>), the number of persons for reservation (<Num>), a scheduled arrival time (<ArrivalTime>) and a menu for order (<Menu>) are inputted.

The format holding unit 306 may hold not only one but plural types of such script format 306a.

FIG. 27 is a diagram showing an example of the script created by the script creation unit 305.

In the script, “251” is inputted as the user ID (<UserID>), “4 persons”, as the number of persons for reservation (<Num>), “18:20”, as the scheduled arrival time (<ArrivalTime>), and “Today's Special/2, Seafood meal/1, Kiddy Lunch/1”, as the menu for order (<Menu>).

The script creation unit 305 transmits such script from the server sending/receiving unit 304 to the store terminal 392, and allows the store terminal 392 to execute the control indicated in the script.

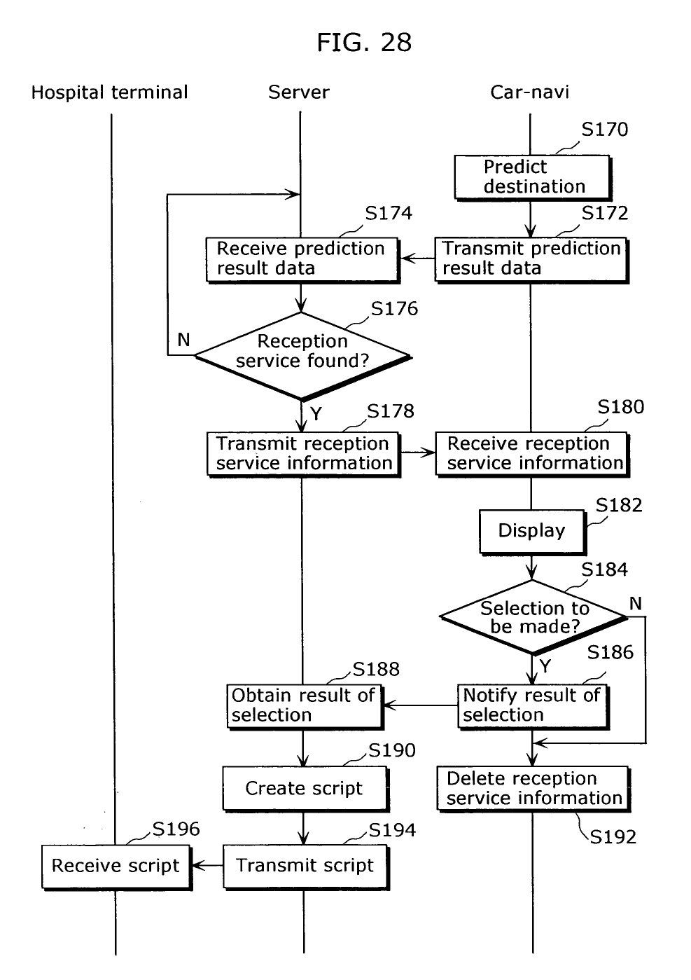

FIG. 28 is a diagram showing a sequence of operations performed in the execution support system according to the present embodiment.

Firstly, the car-navi 100A predicts a destination (Step S170), and transmits, to the server 300, the prediction result data indicating that the destination is “XX Hospital, node number L245” (Step S172).

Then, after having received the prediction result data transmitted from the car-navi 100A (Step S174), the server 300 judges whether or not the reception service which is accepted at the time when the prediction result data is received is registered into the registration information 302a in association with the destination “XX Hospital, node number L245” indicated in the prediction result data (Step S176).

In the case where the reception service available at the received time is registered in association with the destination “XX Hospital, node number L245” (Y in Step S176), the server 300 then transmits, to the car-navi 100A, the reception service information indicating the details of the reception service (Step S178). In the case where the reception service is not registered (N in Step S176), the server 300 repeatedly executes the operation starting from Step S174.

Having obtained the reception service information from the server 300 (Step S180), the car-navi 100A displays the reception service indicated in the reception service information (Step S182), and judges whether or not the user has instructed for selection of reception services (Step S184).

In the case where it is judged that such selection instruction is sent from the user (Y in Step S184), the car-navi 100A notifies the server 300 of the selection result indicating the selected reception services (Step S186). In the case where it is judged that such selection instruction is not sent from the user (N in Step S184), or after the notification of the selection result in Step S186, the car-navi 100A deletes the reception service information obtained from the server 300 (Step S192).

Having obtained the selection result from the server 300 (Step S188), the server 300 creates a script based on it (Step S190). The server 300 then transmits the script to the hospital terminal 391 represented as “XX Hospital, node number L245” that is the destination notified by the car-navi 100A (Step S194).

The hospital terminal 391 receives the script from the server 300, and executes the details indicated in the script (Step S196). For example, the hospital terminal 391 accepts “reservation for consultation/internal medicine” or the like.

Thus, according to the present embodiment, in the case where the car-navi 100A predicts that the car is headed, for example, to a hospital, the server 300 notifies the car-navi 100A of several reception services that are acceptable by the hospital terminal 391, and allows the hospital terminal 391 to execute the reception services selected by the car-navi 100A. Therefore, it is possible to support the device execute a control operation in accordance with the user's behavior while eliminating the cumbersome tasks imposed on the user, and also to enhance the usability by allowing the user to select the reception service that is the control operation.

Note that the registration information 302a held in the server 300 may include a waiting time for each reception service available at each facility. For example, the hospital terminal 391 registers, into the registration information 302a held by the server 300, a waiting time for a consultation at a department of internal medicine in the XX Hospital so that the waiting time is associated with the reception service “reservation for consultation/internal medicine”. The hospital terminal 391 updates the registered waiting time at intervals of predetermined time.

In such case, the reception service information creation unit 303 in the server 300 creates reception service information so that the information includes the waiting time, while the save processing unit 134 in the car-navi 100A having obtained the reception service information allows the display unit 132 to display the waiting time. For example, the save processing unit 134 allows the waiting time to be displayed on the screen as shown in FIG. 25(b) in association with the reception service “reservation for consultation/internal medicine”.

Thus, the user operating the car-navi 100A is informed of the waiting time, which leads to the improvement of the usability.

The reception service information creation unit 303 may further create reception service information so that the information includes the service hours registered into the hours column E5 of the registration information 302a, while the save processing unit 134 in the car-navi 100A having obtained the reception service information may allow the display unti 132 to display the service hours. For example, the save processing unit 134 allows the hours “10:00-12:00, 13:00-15:00” to be displayed on the screen shown in FIG. 25(b) in association with the reception service “reservation for consultation/internal medicine”.

In this way, the user operating the car-navi 100A is informed of the service hours, which improves the usability.

### Third Embodiment

The following describes the execution support system according to the third embodiment of the present invention, with reference to the diagrams.

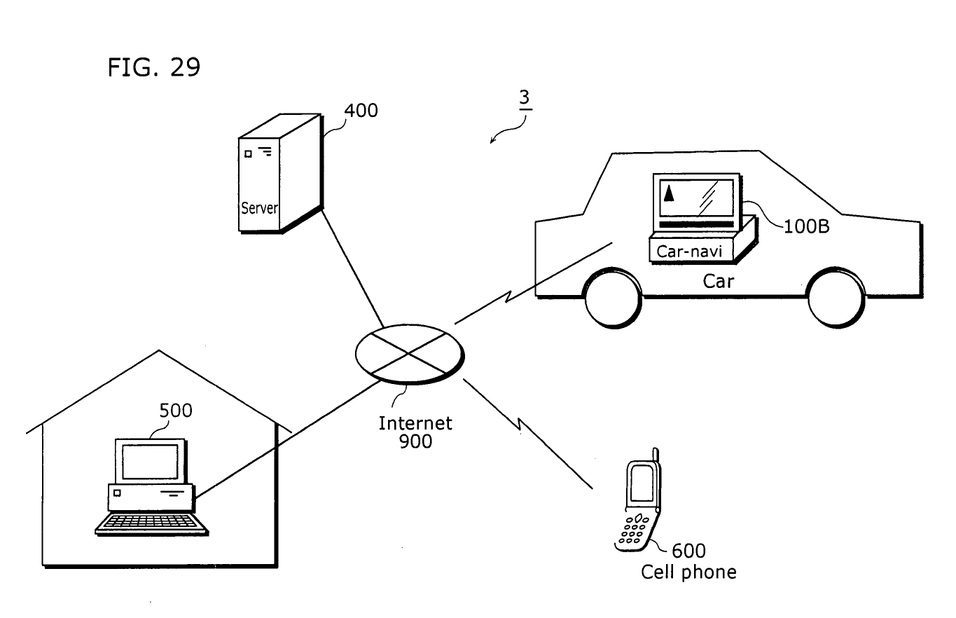

FIG. 29 is a diagram showing a structure of the execution support system according to the present embodiment.

The execution support system 3 according to the present embodiment, as is the case of the first and second embodiments, supports a device execute a control operation in accordance with the user's behavior while eliminating the troublesome operations imposed on the user. Such execution support system 3 includes the following units: a car-navi 100B installed in the car; a home terminal 500 that is set, for instance, in a home place of the user operating the car-navi 100B; a cell phone 600; and a server 400 that communicates with the car-navi 100B, the cell phone 600 and the home terminal 500 via the Internet 900.

Under such execution support system 3, plural types of messages for sending a notification to the car-navi 100B and the cell phone 600 are previously registered into the server 400 by the home terminal 500. In the case where the car-navi 100B predicts that the car is headed to a superstore, the server 400 selects, from among the previously registered messages, a message that corresponds to the user's behavior of “heading for a superstore”, e.g., a message “I want you to get some beef.” and notifies the car-navi 100B of the message, so as to cause the car-navi 100B to execute the control indicating a display of the message “I want you to get some beef”.

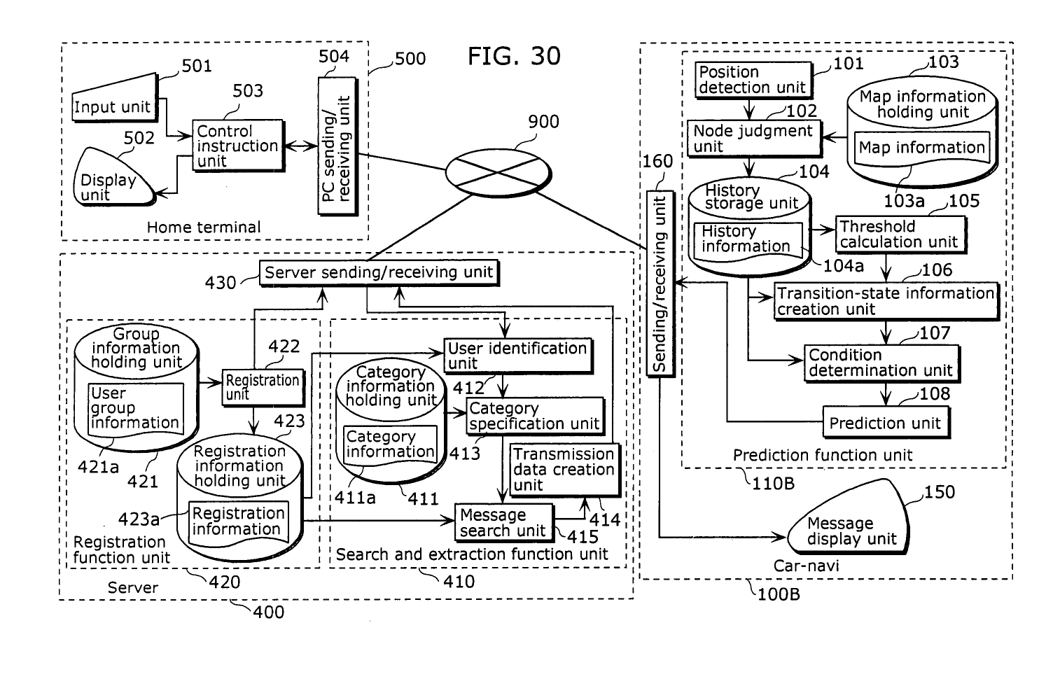

FIG. 30 is a function block diagram showing a functional structure of the car-navi 100B, the server 400, and the home terminal 500.

The car-navi 100B includes a prediction function unit 110B that predicts a destination to which the car-navi 100B is headed; a sending/receiving unit 160 that sends and receives signals via the Internet 900; and a message display unit 150 that displays the message obtained from the server 400 via the sending/receiving unit 160.

The prediction function unit 110B has the same structure and function as the prediction function unit of the first embodiment, and includes the position detection unit 101, the node judgment unit 102, the map information holding unit 103, the history storage unit 104, the threshold calculation unit 105, the transition-state information creation unit 106, the condition determination unit 107, and the prediction unit 108. Such prediction function unit 110B predicts a destination where the car-navi 100B is heading for, and transmits the prediction result data indicating the destination and a scheduled arrival time, from the sending/receiving unit 160 to the server 400 via the Internet 900. The sending/receiving unit 160 transmits, to the server 400, a user ID of the user operating the car-navi 100B together with the prediction result data.

The cell phone 600 has the prediction function unit 100B, the sending/receiving unit 160 and the message display unit 150 having the same structure and function as those of the car-navi 100B.

Knowing that the car-navi 100B and the cell phone 600 are heading for a predetermined destination, the server 400 transmits respectively to the car-navi 100B and the cell phone 600, a message that corresponds to the destination. Such server 400 includes a registration function unit 420 that registers messages, a search and extraction function unit 410 that performs search and extraction of a registered message, and a server sending/receiving unit 430 that sends and receives signals via the Internet 900.

The registration function unit 420 includes: a group information holding unit 421 that previously holds user group information 421a indicating a group to which the user using the present system belongs; a registration unit 422 that accepts a registration of message from the home terminal 500; and a registration information storing unit 423 that has an area for storing, as the registration information 423a, the message accepted by the registration unit 422.

The search and extraction function unit 410 includes the following units: a user identification unit 412 that obtains the prediction result data and the user ID from the car-navi 100B via the server sending/receiving unit 430 and identifies a user specified by the user ID; a category information holding unit 411 that previously holds category information 411a indicating a category of each facility; a category specification unit 413 that specifies a category of the destination indicated in the prediction result data; a message search unit 415 that searches for a message in the registration information 423a; and a transmission data creation unit 414 that creates transmission data for transmitting the message extracted through the search.

In contrast, the home terminal 500 includes the following units: an input unit 501 made up of a keyboard and a mouse which constitutes, for example, a personal computer and outputs an operation signal that corresponds to the user's operation; a display unit 502 that displays characters and graphics; a PC sending/receiving unit 504 that sends and receives signals via the Internet 900; and a control instruction unit 503 that controls the display unit 502 and the PC receiving/sending unit 504.

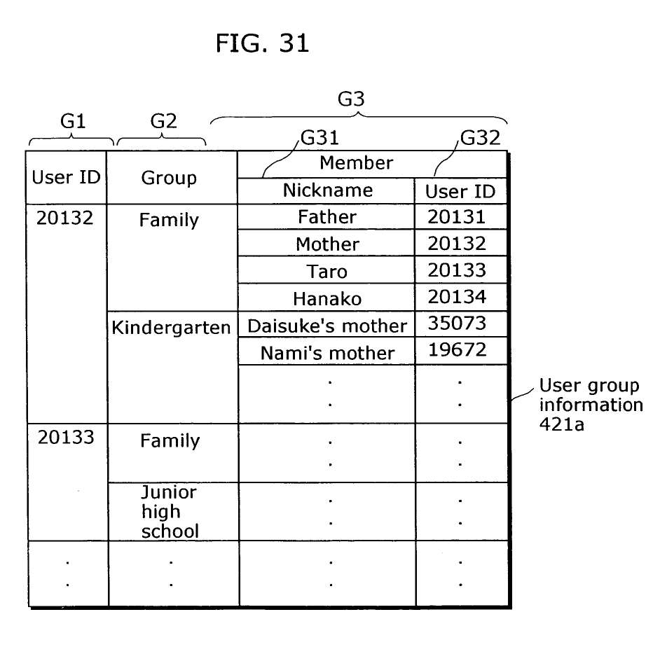

FIG. 31 is an information display diagram showing the details included in the user group information 421a held in the group information holding unit 421.

The user group information 421a has the following columns: a user ID G1; a group G2; and a member G3. The membercolumn G3 includes a nickname column G31 and a member user ID column G32. A user ID of the user utilizing the present system is registered into the user ID column G1, and a group to which the user belongs is registered into the group column G2, while a member of the group is registered into the member column G3. A nickname given to each user is registered into the nickname column G31, and a user ID assigned to a member (i.e. user) with the nickname is registered into the member user ID column G32.

For example, in the user group information 421a, a user ID “20132” of a nickname “Mother” using the home terminal 500 is registered into the user ID column GI. Groups such as “family” and “kindergarten” to which “Mother” belongs are registered into the group column G2, nicknames such as “Father”, “Mother”, “Taro” and “Hanako” are registered into the nickname column G31 in association with the group “family”, while a user ID “20131” of the nickname “Father” is registered into the member user ID column F32 in association with the nickname “Father”.

Being accessed by the home terminal 500 via the internet 900, the registration unit 422 allows the display unit 502 to display a screen for accepting a message to be registered into the registration information 423a.

The registration unit 422 allows the screen to be displayed based on the user group information 421a.

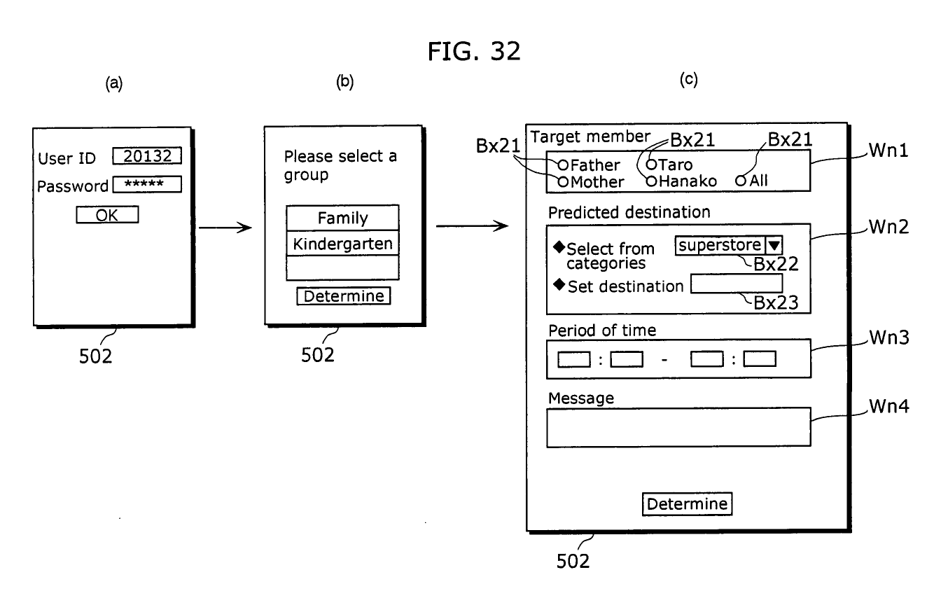

FIGS. 32(a) through 32(c) are screen display diagrams respectively showing an example of the screen which the registration unit 422 allows the display unit 502 of the home terminal 500 to display.

When being accessed by the home terminal 500, the registration unit 422 allows the display unit 502 to display a screen for inquiring on a user ID and a password of the user operating the input unit 501 of the home terminal 500, as shown in FIG. 32(a).

When the user “Mother” inputs her user ID and password by operating the input unit 501 of the home terminal 500, the registration unit 422 obtains the user ID “20132” and the password from the home terminal 500, and judges whether or not the user “Mother” is a valid user based on the user ID and the password. In the case of judging that the user “Mother” is a valid user, the registration unit 422 searches the user ID “20132” in the user ID column G1 of the user group information 421a.

Since the user ID “20132” is registered into the user ID column G1 of the user group information 421a, the registration unit 422 specifies the group “family” and “kindergarten” registered into the group column G2 in association with the user ID, and allows the display unit 502 to display a screen for inquiring on which group a sender of the message belongs to, as shown in FIG. 32(b).

When the user “Mother” selects the group “family” by operating the input unit 501 of the home terminal 500, the registration unit 422 knows that the group “family” is selected, inquires on the member to whom a message should be sent, out of the members registered into the user group information 421a in association with the group “family”, and allows the display unit 502 to display a screen for inquiring about the details of the message. Here, the registration unit 422 allows the display unit 502 to also display a screen for inquiring about conditions under which a message should be sent. The conditions here are a destination where a member to whom the message is to be sent, and a scheduled arrival time at which the member arrives at the destination.

In other words, when predicting where and at what time the member arrives, the registration unit 422 inquires a member in the selected group of a message to be transmitted.

As shown in FIG. 32(c), the registration unit 422 allows the display unit 502 to display a target member frame Wn1, a predicted destination frame Wn2, a time frame Wn3 and a message frame Wn4.

In the user group information 421a, the followings are registered in association with the group “family”: the nickname “Father” and the user ID “20131”; the nickname “Mother” and the user ID “20132”; the nickname “Taro” and the user ID “20133”; and the nickname “Hanako” and the user ID “20134”. Therefore, when the group “family” is selected, the registration unit 422 allows the nicknames “Father”, “Mother”, “Taro”, and “Hanako” as well as “A11” to be displayed in the target member frame Wn1.

Here, when the user “Mother” desires to send a message to the nickname “Father”, the user “Mother” operates the input unit 501 of the home terminal 500 and ticks the check box Bx21 displayed on the left of the nickname “Father” among the check boxes Bx21 on the left of each of the nicknames shown within the target member frame Wn1.

The registration unit 422 also allows a display of a selection box Bx22 for selecting a category to which a facility such as “superstore”, “restaurant” or “fitness facility” belongs, and an input box Bx23 for inputting a name of the facility instead of its category.

In the case where the user “Mother” desires to send a message to the nickname “Father” while heading for a destination “superstore”, the user “Mother” operates the input unit 501 of the home terminal 500 so that the destination “superstore” is displayed in the selection box Bx22. In the case where the user “Mother” predicts that the nickname “Father” arrives at the destination “superstore” at the time “15:00-19:30” and desires to send a message, the user “Mother” operates the input unit 501 of the home terminal 500 so as to input the time “15:00-19:30” into the time frame Wn3. The user “Mother” then operates the input unit 501 to input, for example, the message “I want you to buy 400 g of beef” that she wants to send to the nickname “Father”, into the message frame Wn4.

When the user “Mother” inputs the message or the like and determines the details of the input, the registration unit 422 registers the inputted details into the registration information 423a.

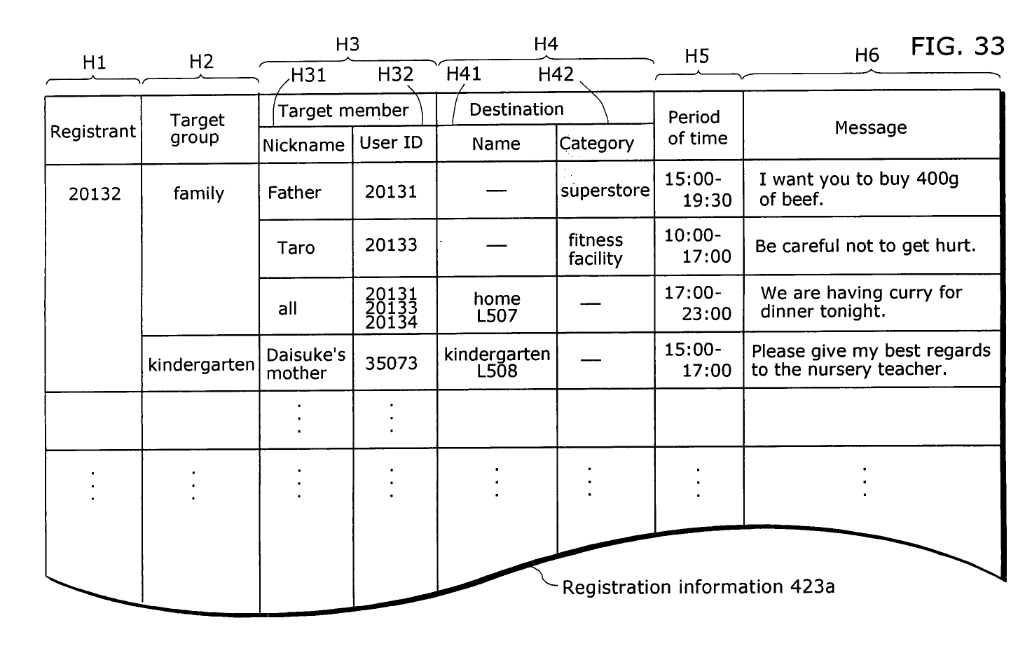

FIG. 33 is an information display diagram showing the details included in the registration information 423a stored in the registration information storing unit 423.

The registration information 423a has the following columns: a registrant H1, a target group H2, a target member H3, a destination H4, a time H5, and a message H6. The target member column H3 has a nickname column H31 and a user ID column H32, while the destination column H4 has a name column H41 and a category column H42.

In the registrant column H1, a user ID of the registrant (i.e. user “Mother”) who has registered by operating the home terminal 500. In the target group column H2, groups such as “family” and “kindergarten” selected by the registrant are registered. In the nickname column H31 of the target member column H3, nicknames of the members selected by the registrant are registered in association with the group, while in the user ID column H32, user IDs of the users having such nicknames are registered. In the name column H41 of the destination column H4, a name of the destination specified by the registrant for each member as well as its node number is registered. In the category column H42 of the destination column H4, a category of the destination specified by the registrant for each member is registered. A time that is set by the registrant for each target member is registered into the time column H5, while a message inputted by the registrant is registered into the message column H6.

For example, in the case where the user “Mother” registers as shown in FIGS. 32A through 32C, the registration unit 422 registers, as the registration information 423a, the user ID “20132” of the user “Mother” into the registrant column H1, the group “family” into the target group column H2, the nickname “Father” and the user ID “20131” into the target member column H3, and the destination “superstore” into the category column H42 of the destination H4. The registration unit 422 further registers the time “15:00-19:30” associated with the nickname “Father” of the target member into the time H5, and the message “I want you to buy 400 g of beef”, into the message column H6. In the case where the user ID “20132” of the user “Mother” is already registered into the registrant column H1, and the group “family” is already registered into the target group column H2, other information is registered, for example, into the target member column H3, without performing registration for the registrant column H1 and the target group column H2. Plural messages may be registered for the same member according to destination and time.

Note that when the user “Mother” inputs a name of facility into the input box Bx23 of the predicted destination frame Wn2 on the screen shown in FIG. 32(c), the registration unit 422 refers, for example, to the data into which a name of facility and its node number are previously inputted, and registers the inputted name and node number into the destination column H4 of the registration information 423a.

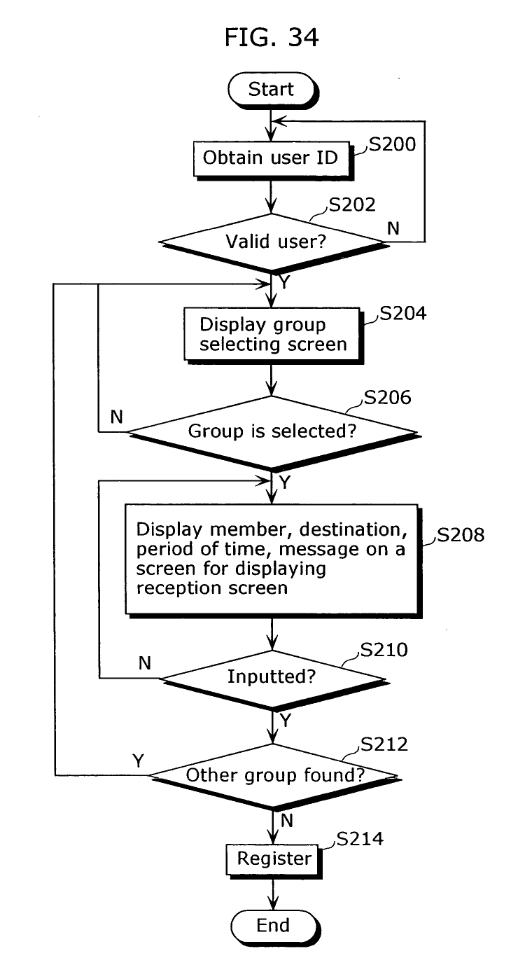

The following describes the operation performed by the registration function unit 420 of the server 400 according to the present embodiment, with reference to FIG. 34.

FIG. 34 is a flowchart showing the operation performed by the registration function unit 420 of the server 400.

Firstly, the registration unit 422 obtains, from the home terminal 500, a user ID and a password of the user who has come to access (Step S200), and judges whether or not the user is a valid user (Step S202).

In the case of judging that the user is a valid user (Y in Step S202), the registration unit 422 allows the display unit 502 to display a screen (i.e. a group selecting screen) for allowing the user to select a group as shown in FIG. 32(b) (Step S204). In the case of judging that the user is not a valid user (N in Step S204), the registration unit 422 repeatedly executes the operation starting from Step S200.

After the execution of Step S204, the registration unit 422 judges whether or not a group is selected (Step S206). In the case of judging that a group is selected, the registration unit 422 allows the display unit 502 to display a screen (i.e. a message setting screen) for accepting members, destination, time and message as shown in FIG. 32(c) (Step S208). In the case of judging that a group is not selected, the registration unit 422 repeatedly executes the operation starting from Step S208.

After the execution of Step S208, the registration unit 422 judges whether or not destination and time are inputted (Step S210). In the case of judging that all the information is inputted (Y in Step S210), the registration unit 422 further judges whether another group is to be selected or not by inquiring the user operating the home terminal 500 of it (Step S212). In the case of judging that not all the information is inputted (N in Step S210), the registration unit 422 repeatedly executes the operation starting from Step S208. In the case of judging that another group is to be selected (Y in Step S212), the registration unit 422 executes the operation starting from Step S204.

In the case of judging that another group is not to be selected (N in Step S212), the registration unit 422 registers, into the registration information 423a, the group selected in Step S206 and the details inputted in Step S210 (Step S214).

Having obtained the prediction result data and the user ID from the car-navi 100B via the server sending/receiving unit 430, the user identification unit 412 of the search and extraction function unit 410 in the server 400 judges whether or not the user ID is registered into the target member column H3 of the registration information 423a. In the case of judging that the user ID is registered into the target member column H3, the user identification unit 412 notifies the category specification unit 413 of the prediction result data and the user ID.

The category specification unit 413 refers to the category information 411a held in the category information holding unit 413, judges whether or not the destination indicated in the prediction result data belongs to a predetermined category, and specifies the category.

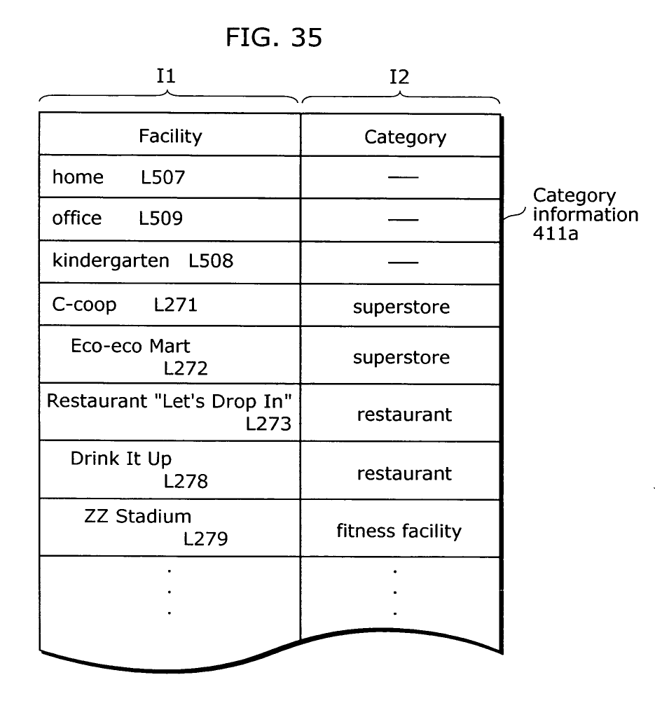

FIG. 35 is an information display diagram showing the details included in the category information 411a held in the category information holding unit 411.

The category information 411a is previously held for each user, and has a facility column I1 and a category column I2. A name of facility and its node number are registered into the facility column I1 while a category to which the facility belongs is registered into the category column I2.

For example, “home, node number L507”, “company, node number L509”, “kindergarten, node number L508”, “C-coop, node number L271”, “Eco-eco Mart, node number L272” and “restaurant ‘Let's Drop In’, node number L273” are registered into the facility column I1 of the category information 411a. The followings are registered into the category column I2 of the category information 411a: “superstore” associated with “C-coop”; “superstore” associated with “Eco-eco Mart”; and “restaurant” associated with “restaurant ‘Let's Drop In’”.

That is to say that the category information 411a indicates that the facilities “C-coop” and “Eco-eco Mart” belong to the category “superstore” and the facility “restaurant ‘Let's Drop In” belongs to the category “restaurant”. In other words, the category information 411a indicates that the facilities that belong to the category “superstore” are the facilities “C-coop” and “Eco-eco Mart”, and the facility that belongs to the category “restaurant” is the facilities “restaurant ‘Let's Drop In’” and “Drink It Up”.

Each of the facilities such as “home”, “company” and “kindergarten” is a facility related only to the user, and therefore, it does not belong to any category.

In the case where the prediction result data obtained from the car-navi 100B indicates the destination “C-coop, node number L271”, the category specification unit 413 searches for “C-coop, the node number L271” in the facility column I1 of the category information 411a. The category specification unit 413 then judges whether or not the category is registered into the category column I2 in association with the facility “C-coop, node number L271”. As the category “superstore” is registered into the category information 411a in accordance with “C-coop, node number L271”, the category specification unit 413 specifies the category “superstore” as the category of the facility “C-coop” being a destination. The category specification unit 413 then notifies the message search unit 415 of the specified category.

In the case where the prediction result data obtained from the car-navi 100B indicates, for example, the destination “home, node number L507”, the category specification unit 413 does not perform the notification of category since the category of the destination “home, node number L507” is not registered into the category information 411a.

Having obtained the prediction result data and the user ID from the car-navi 100B, the message search unit 415 searches, in the registration information 423a, for a message specified by the prediction result data and the user ID. In the case where the category is notified by the category specification unit 413, the message search unit 415 searches the message using the notified category.

For example, in the case where the prediction result data indicates the destination “C-coop, node number L271” and the scheduled arrival time “19:00”, and the user ID indicates “20131”, the message search unit 415 firstly searches for the user ID “20131” in the target member column H3. After having received, from the category specification unit 413, the notification that the category of the destination (i.e. facility) is “superstore”, the message search unit 415 judges whether or not the category “superstore” is registered in association with the user ID “20131” into the category column H42 of the registration information 423a. In the case where the category “superstore” is registered, the message search unit 415 further judges whether or not “19:00” is included in the time registered into the time column H5 in association with the user ID “20131” and the category “superstore”.

As shown in FIG. 33, the category “superstore” is registered into the category H42 of the registration information 423a and the time “15:00-19:30” is registered into the time H5, in association with the user ID “20131”. Therefore, the message search unit 415 judges that the category “superstore” is registered into the category column H42 in association with the user ID “20131” and the time “19:00” is included in the time registered in association with the user ID “20131” and the category “superstore”.

As a result, the message search unit 415 specifies the message “I want you to buy 400 g of beef” registered, in association with the user ID “20131” and the category “superstore”, into the message column H6 of the registration information 423a. That is to say that the message search unit 415 searches for the destination indicated in the prediction result data and the message that corresponds to a scheduled arrival time, and specifies the message.

The message search unit 415 then notifies the transmission data creation unit 414 of the message specified through the search.

Having received the notification, the transmission data creation unit 414 creates transmission data for notifying the message via an e-mail for example, and allows the transmission data to be transmitted from the server sending/receiving unit 430 to the car-navi 100B.

Having obtained the transmission data via the sending/receiving unit 160 of the car-navi 100B, the message display unit 150 of the car-navi 100B displays a message indicated in the transmission data.

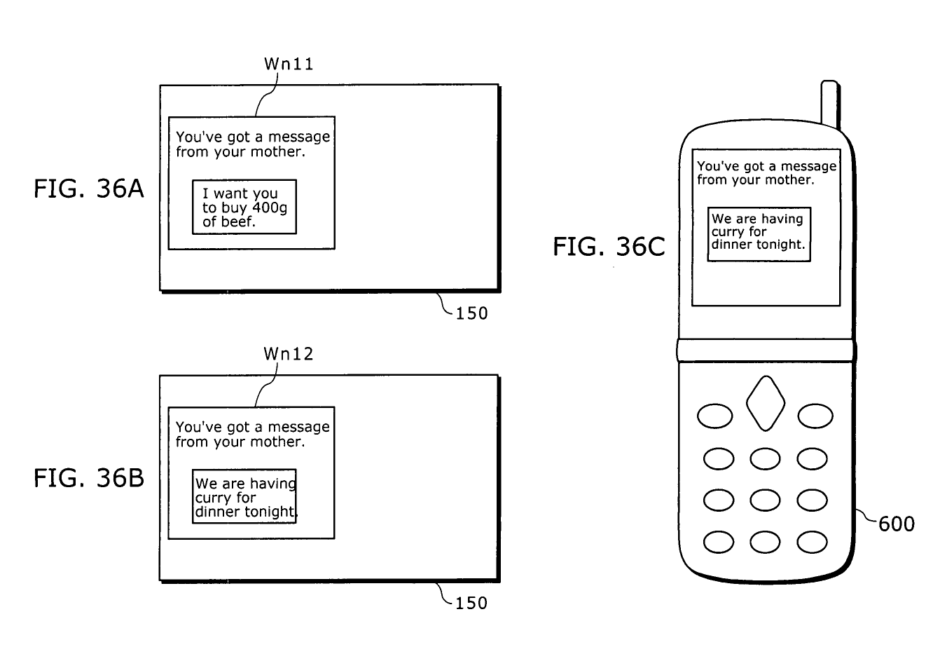

FIGS. 36A and 36B are screen display diagrams respectively showing an example of the screen displayed by the message display unit 150 of the car-navi 100B.

As shown in FIG. 36A, the message display unit 150 displays a message window Wn11, in which a text “You've got a message from your mother” and the searched-out message “I want you to buy 400 g of beef” are displayed.

In the case where “Father”, who is a member of the group “family” and also a user operating the car-navi 100B, is on his way home, the server 400 transmits, to the car-navi 100B, the transmission data of the message registered into the registration information 423a in association with the member “Father” and the destination “home”, so that the text “You've got a message from your mother” and a message “We are having curry for dinner tonight” are displayed in the message window Wn12, as shown in FIG. 36B.

FIG. 36C is a screen display diagram showing an example of the screen displayed by a message display unit of the cell phone 600.

In the case where “Taro”, who is a user using the cell phone 600 and also a member of the group “family”, is on his way home, transmission data of the message that is registered into the registration information 423a in association with the member “Taro” and the destination “home” is transmitted from the server 400 to the cell phone 600, so that the text “You've got a message from your mother” and the message “We are having curry for dinner tonight” are displayed by the message display unit of the cell phone 600 as shown in FIG. 36C.

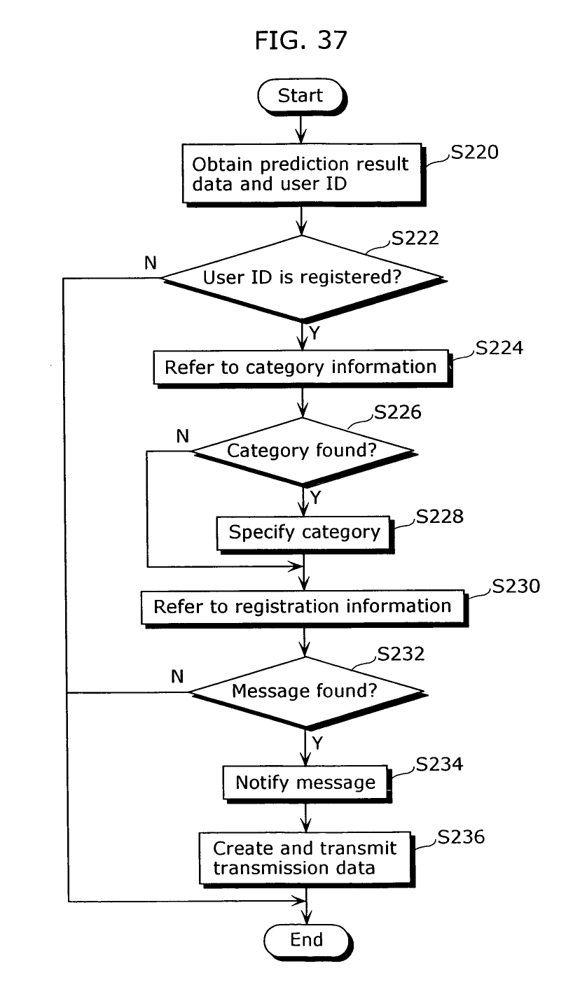

The following describes the operation performed by the search and extraction function unit 410 of the server 400 according to the present embodiment, with reference to FIG. 37.

FIG. 37 is an operational flowchart showing the operation performed by the search and extraction function unit 410 of the server 400.

Firstly, having obtained prediction result data and a user ID from the car-navi 100B (Step S220), the user identification unit 412 judges whether or not the user ID is registered into the target member column H3 of the registration information 423a (Step S222).

In the case of judging that the user ID is registered (Y in Step S222), the user identification unit 412 notifies the category specification unit 413 of the prediction result data and the user ID, while the category specification unit 413 refers to the category information 411a (Step S224) and judges whether or not the destination indicated in the prediction result data belongs to a predetermined category (Step S226).

As a result, in the case of judging that the destination belongs to the predetermined category (Y in Step S226), the category specification unit 413 specifies the category and notifies the message search unit 415 of the category (Step S228).

Next, the message search unit 415 refers to the registration information 423a (Step S230), and judges whether or not the message associated with the following is registered into the registration information 423a: the user ID from the car-navi 100B; the destination indicated in the prediction result data; a category in the case where the category is specified; and the scheduled arrival time indicated in the prediction result data (Step S232).

In the case where the message is registered into the registration information 423a (Y in Step S232), the message search unit 415 notifies the transmission data creation unit 414 of the message (Step S234), while the transmission data creation unit 414 creates transmission data indicating the message and transmits the transmission data to the car-navi 100B (Step S236).

Under such execution support system 3, in the case where it is predicted that the car-navi 100B or the cell phone 600 is heading for a predetermined destination, the server 400 selects a message that corresponds to the destination from among the pre-registered messages, and allows the car-navi 100B or the cell phone 600 to execute control, that is, a display of the message. This abbreviates the cumbersome tasks imposed on the user, such as an inquiry like “I'm on the way to the superstore. Do you want me to get anything?”, and the user can receive a message in accordance with the user's behavior.

Note that the server 400 of the present embodiment may search for a facility that belongs to the same category as that of the destination in the vicinity of present position of the car-navi 100B, and transmit, to the car-navi 100B, the transmission data which includes a message notifying name and place of the facility.

In this case, the prediction function unit 110B of the car-navi 100B transmits, to the server 400, the prediction result data including the present position detected by the position detection unit 101. The server 400 judges whether or not the destination included in the prediction result data belongs to a predetermined category. In the case of judging that the destination belongs, for example, to the category “superstore”, the server 400 searches for a “superstore” located in the vicinity of the present position included in the prediction result data, through its own data base and the Internet. The server 400 may search for a “superstore” which is near the present position and matches the conditions such as “sales at bargain prices” and “sales during limited hours”. In the case where the facility that matches with the conditions as a result of the search, the server 400 transmits, to the car-navi 100B, the message “I want you to buy 400 g of beef” included in the registration information 423a together with the transmission data that includes a message “sales during limited hours” in the superstore “Eco-eco Mart” at the intersection A nearby”.

Thus, the message is displayed by the message display unit 150 of the car-navi 100B so that the user operating the car-navi 100B is not bothered to go as far as the destination and can shop at the superstore located nearby, and can also select the superstore that matches best the conditions. This improves usability for the user.

The server 400 according to the present embodiment may further allow the operation to be executed in accordance with the response from the car-navi 100B or the cell phone 600.

For example, the server 400 transmits the transmission data that includes the message “I want you to buy 400 g of beef”, to the car-navi 100B and the cell phone 600. When the user operating the car-navi 100B, who has read the message “I want you to buy 400 g of beef” included in the transmission data, actually gets 400 g of beef and operates the car-navi 100B for sending back a message informing of the purchase to the server 400. In the case where the server 400 has not yet obtained a reply message informing of the purchase from the cell phone 600, at the time of receiving the message replied from the car-navi 100B, the server 400 transmits, to the cell phone 600a, a message indicating that “the purchaser of 400 g of beef is the user (i.e. Father) operating the car-navi 100B”.

Thus, the user of the cell phone 600 knows that there is no need to buy 400 g of beef as is written in the message, since he/she has already bought it. This prevents the user operating the car-navi 100B and the user using the cell phone 600 from buying 400 g of beef. Thus, usability is further enhanced.

The registration function unit 420 of the server 400 according to the present embodiment may include a user information holding unit that previously holds user information, while the registration unit 422 of the server 400 may allow the display unit 502 of the home terminal 500 to display a screen for inquiring on group or category. In the user information, user IDs of predetermined target members, groups of the members, and categories of destination are registered as initial settings, and also, user IDs of the target members that are registered in the past are registered as a history. In the case where the registration unit 422 allows the display unit 502 of the home terminal 500 to display a group selecting screen, the groups registered as initial settings into the user information and the groups that are frequently registered as a history in recent days are displayed, for instance, on the top of the screen or larger, so that they are easily selected by the home terminal 500. As shown in FIG. 32(c), in the case where the registration unit 422 allows the display unit 502 to display the target member frame Wn1 and the predicted destination frame Wn2, the target members and categories registered as initial settings into the user information, or the target members and categories which are frequently registered as a history in recent days are displayed in the state where the check box Bx21 is ticked or in the state where a category is inputted into the selection box Bx22, so that they are easily selected by the home terminal 500.

Thus, the server 400 has a so-called learning function, as in the second embodiment, by the fact that the registration unit 422 displays a screen for inquiring on group or category based on the user information, so that the usability for the user operating the home terminal 500 is improved.

Note that the present embodiment shows the example of the case where the user “Mother” sends a message toward a group member “Father”, however, the user “Mother” may send a message to herself. That is to say that the user “Mother” selects herself as the member to whom a message is sent, and previously registers the message into the registration information 423a.

Thus, for example, in the case where a name of the video that the user “Mother” desires to rent is registered into the registration information 423a as a message, the name of the video is displayed as a message by the car-navi 100B as the user “Mother” approaches to the rental shop while driving the car in which the car-navi 100B is set. The user “Mother” therefore can immediately be informed of the name even in the case she forgets it.

Note that through the first to third embodiments, the respective car-navi 100, 110A, 110B and the cell phone 600 have the components such as the position detection unit 101 and the map information holding unit 103, however, they may have at least the position detection unit 101, or another device other than the above mobile terminals may have the components other than the position detection unit 101. For example, another device except for the car-navi 100B may include the message display unit 150 according to the third embodiment, and another device except for the car-navi 100A may include the operation unit 131 according to the second embodiment. Another server may include the map information holding unit 103 and the node judgment unit 102 or the like so that a mobile terminal such as the car-navi 110 equipped with the position detection unit 101 and the server can communicate with each other via the Internet 900.

In this way, by placing the position detection unit 101 into a mobile terminal such as the car-navi 110 and placing other components except for the position detection unit 101 into another device different from the mobile terminal mentioned above reduction in size and weight of mobile terminal can be achieved.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The execution support system according to the present invention is effective in eliminating cumbersome operations imposed on a user and supporting a device to execute control in accordance with the user's behavior. Such system is useful for supporting a terminal device that is placed in a hospital or a store, and a cell phone, execute control.

1-29. (canceled)

30. An execution support system for supporting a predetermined device execute a control operation, said system comprising:
a mobile terminal that predicts a destination to which said terminal is headed, and outputs prediction result data indicating a result of the prediction;
a control operation specification unit operable (i) to hold registration information in which a category to which a facility belongs, and a control operation of the device are registered, the control operation corresponding to the category, (ii) to judge whether or not a destination facility indicated in the prediction result data belongs to a predetermined category, and (iii) to specify a control operation corresponding to the predetermined category among control operations registered in the registration information, in the case where it is judged that the destination facility belongs to the predetermined category; and
an execution unit operable to cause the device to execute the control operation specified by said control operation specification unit.

31. The execution support system according to claim 30,
wherein the control operation registered in the registration information is a transmission of a message or a display of a message.

32. The execution support system according to claim 30,
wherein the category registered in the registration information is restaurant.

33. The execution support system according to claim 30,
wherein a period of time related to each control operation is registered in the registration information, and
said control operation specification unit is further operable to specify a control operation associated with a period of time that includes a time indicated in the prediction result data.

34. The execution support system according to claim 33,
wherein identification information for identifying a device that executes a control operation is registered in the registration information in association with each control operation,
said control operation specification unit is operable to specify, among the control operations registered in the registration information, a control operation indicated in the prediction result data and identification information of a device that executes the control operation, and
said execution unit is operable to cause the device to execute the control operation specified by the control operation specification unit, the device being indicated in the identification information specified by said control operation specification unit.

35. The execution support system according to claim 34,
wherein, in the registration information, user identification information for identifying each user is registered in association with each control operation,
said mobile terminal outputs user identification of a user operating said terminal, and
said control operation specification unit is operable to specify, among the control operations registered in the registration information, a control operation that is further indicated in the user identification information outputted by said mobile terminal.

36. The execution support system according to claim 35, further comprising
an update unit operable to update the registration information held by said control operation specification unit.

37. The execution support system according to claim 36,
wherein said control operation specification unit is operable to notify said mobile terminal of candidates for a control operation of the device, the candidates being specified according to the prediction result data, and to specify a control operation selected by said mobile terminal among the candidates.

38. The execution support system according to claim 37,
wherein said control operation specification unit is operable to store, as a history, a result of the selection made by said mobile terminal, and to notify said mobile terminal of a frequently-selected control operation in priority to other control operations.

39. The execution support system according to claim 38,
wherein the control operation is starting up the device.

40. The execution support system according to claim 38,
wherein the control operation is a display of a message.

41. The execution support system according to claim 40,
wherein said mobile terminal derives a scheduled arrival time to arrive at a predicted destination and includes the scheduled arrival time in the prediction result data, and
said execution unit is operable to cause the device to display a message that includes the scheduled arrival time.

42. The execution support system according to claim 38,
wherein the control operation is a registration of information indicating details of a reservation made with regard to the destination.

43. The execution support system according to claim 42,
wherein said execution unit is operable to create a script for causing the device to execute a control operation, and to transmit the script to the device.

44. The execution support system according to claim 43,
said execution unit is operable to previously hold a format of the script and a parameter, and to create a script that indicates a control operation, by inputting the parameter into the format.

45. The execution support system according to claim 44,
wherein said execution unit is operable to cause said mobile terminal to serve as the device, and to cause the mobile terminal to execute the control operation specified by said control operation specification unit.

46. The execution support system according to claim 45,
wherein said mobile terminal is a terminal in a car navigation system, or a cell phone.

47. The execution support system according to claim 46,
wherein said mobile terminal includes said control operation specification unit and said execution unit, and
said execution unit is operable to cause the device to execute the control operation, via an electrical communication line.

48. The execution support system according to claim 46,
wherein a server includes said control operation specification unit and said execution unit,
said mobile terminal transmits the prediction result data to the server via an electrical communication line, and
said execution unit in the server is operable to cause the device to execute the control operation, via the electrical communication line.

49. The execution support system according to claim 46,
wherein a server includes said control operation specification unit and said execution unit,
said mobile terminal transmits the prediction result data to the server via the electrical communication line, and
said execution unit in the server is operable to cause said mobile terminal to execute the control operation, via the electrical communication line.

50. A server included in an execution support system for supporting a predetermined device execute a control operation, said server comprising:
an obtainment unit operable to obtain prediction result data indicating a result of prediction for a destination to which a mobile terminal is headed;
a control operation specification unit operable to specify a control operation of the device, the control operation being specified according to the prediction result data; and
an execution unit operable to cause the mobile terminal to serve as the device, and to cause the mobile terminal to execute the control operation specified by said control operation specification unit.

51. An execution support method for supporting a predetermined device execute a control operation, said method comprising:
a prediction step of predicting a destination to which a mobile terminal is headed, and outputting prediction result data indicating a result of the prediction, said prediction step being performed by the mobile terminal;
a control operation specification step of specifying a control operation of the device, the control operation being specified according to the outputted prediction result data; and
an execution step of causing the device to execute the control operation specified in said control operation specification step.

52. The execution support method according to claim 51,
wherein said control operation specification step includes:
a candidate notification sub-step of notifying the mobile terminal of candidates for a control operation of the device, the candidates being specified according to the prediction result data; and
a candidate selection sub-step of selecting one from among the notified candidates for the control operation, said candidate selection sub-step being performed by the mobile terminal;
wherein the control operation selected in said candidate selection sub-step is specified.

53. An execution support method for supporting a predetermined device execute a control operation, said method comprising:
a prediction step of predicting a destination to which a mobile terminal is headed, and outputting prediction result data indicating a result of the prediction, said prediction step being performed by the mobile terminal;
a control operation specification step of (i) holding registration information in which a category to which a facility belongs and a control operation of the device are registered, the control operation corresponding to the category, (ii) judging whether or not a destination facility indicated in the prediction result data belongs to a predetermined category, and (iii) specifying a control operation corresponding to the predetermined category, among control operations registered in the registration information, in the case where it is judged that the destination facility belongs to the predetermined category; and
an execution step of causing the device to execute the control operation specified in said control operation specification step.

54. An execution support method used by a server included in an execution support system for supporting a predetermined device execute a control operation, said method comprising:
an obtainment step of obtaining prediction result data indicating a result of prediction for a destination to which a mobile terminal is headed;
a control operation specification step of specifying a control operation of the device, the control operation being specified according to the prediction result data; and
an execution step of causing the mobile terminal to serve as the device, and causing the mobile terminal to execute the control operation specified in said control operation specification step.

55. A program for a mobile terminal that supports a predetermined device execute a control operation, said program causing a computer to execute:
a prediction step of predicting a destination to which the mobile terminal is headed, and outputting prediction result data indicating a result of the prediction, said prediction step being performed by the mobile terminal;
a control operation specification step of specifying a control operation of the device, the control operation being specified according to the outputted prediction result data; and
an execution step of causing the device to execute the control operation specified in said control operation specification step.

56. A program for supporting a predetermined device execute a control operation, said program causing a computer to execute:
a prediction step of predicting a destination to which a mobile terminal is headed, and outputting prediction result data indicating a result of the prediction, said prediction step being performed by the mobile terminal;
a control operation specification step of (i) holding registration information in which a category to which a facility belongs, and a control operation of the device are registered, the control operation corresponding to the category, (ii) judging whether or not a destination facility indicated in the prediction result data belongs to a predetermined category, and (iii) specifying a control operation corresponding to the predetermined category, among control operations registered in the registration information, in the case where it is judged that the destination facility belongs to the predetermined category; and
an execution step of causing the device to execute the control operation specified in said control operation specification step.
